(19) United States
(12) Patent Application Publication
(10) Pub. No.: US 2026/0320299 A1
(43) Pub. Date: Oct. 15, 2026

(54) SYSTEM AND METHOD FOR REAL-TIME ANALYSIS OF BROADCASTED MEDIA

(71) Applicants: New York University, New York, NY (US); Georgia Tech Research Corporation, Atlanta, GA (US)

(72) Inventors: Chinmay Hegde, New York, NY (US); Govind Mittal, Brooklyn, NY (US); Mustaque Ahamad, Atlanta, GA (US)

(21) Appl. No.: 19/532,784

(22) Filed: Feb. 6, 2026

Related U.S. Application Data
(60) Provisional application No. 63/754,821, filed on Feb. 6, 2025.

(51) Int. Cl. G06F 40/30; G06F 16/334; G10L 15/26

(52) U.S. Cl. CPC G06F 40/30; G06F 16/334; G10L 15/26

(57) ABSTRACT

A system and method for automatically and simultaneously acquiring, recording, transcribing, diarizing, analyzing, and reporting content from a plurality of single-media and multi-media broadcasts is disclosed. The analytics may include specified content identification, speaker identification, general audio content identification, transcription and diarization, broadcast content classification and differentiation, speaker sentiment analytics, and content pervasiveness analytics. Further, some embodiments of the system and method automatically and simultaneously execute multiple recording instances for numerous broadcast inputs based on selection by an operator and/or a computing machine.

### CROSS-REFERENCE TO RELATED APPLICATIONS

This application claims priority to U.S. Provisional Application No. 63/754,821 filed on Feb. 6, 2025, incorporated herein by reference in its entirety.

### STATEMENT REGARDING FEDERALLY SPONSORED RESEARCH OR DEVELOPMENT

This invention was made with government support under 2154118 and 2154119 awarded by the National Science Foundation. The government has certain rights in the invention.

### BACKGROUND OF THE INVENTION

Radio broadcasts are notoriously difficult to monitor accurately. Since the early 20th century, radio has been a cornerstone of mass media alongside television and newspapers. Radio remains a pervasive medium for mass information dissemination, with AM/FM stations reaching more Americans than either smartphone-based social networking or live television. Increasingly, radio broadcasts are also streamed online and accessed over the Internet.

Despite the rise of the World Wide Web and the emergence of social media networks, radio as a cornerstone of mass media has demonstrated remarkable staying power. Since 2018, even though television viewership and print readership have plummeted by 29%, radio listenership has experienced a mere 7% decrease (see Westwood one, 2024). This resilience is further underscored by radio's dominance in terms of its reach among the public. In 2023, AM/FM radio can be freely accessed by over 84% of U.S. adults, outperforming both smartphone-based social networking (78%) and live TV (72%) (see Pew Research Center. News platform fact sheet, 2024 and Westwood one, 2024).

Corroborating this trend, a Pew Research Center study estimates that nearly half of U.S. adults regularly or occasionally turn to radio for news.

Radio's enduring relevance stems from its unique attributes. In contrast to global social media platforms, radio's focus is primarily hyperlocal and fosters deep community connections through content tailored to specific geographical areas (such as towns, counties, and states). Radio's primary function is as a one-way communication channel, allowing listeners to passively engage during their everyday activities, such as during commutes and/or at work. Many radio broadcasts are spontaneous and ephemeral, and the irreversible nature of radio broadcasts lends authenticity and immediacy to their content, which is particularly crucial in political discourse. These features have positioned radio as a trusted, community-oriented medium that provides an alternative to the deluge of social media content and gives (to some) welcome respite during digital fatigue.

While these distinctions make radio unique as a medium, they also make radio content much more challenging to monitor.

Radio stations sometimes function within micro-echo chambers. The content broadcast by a talk show, for example, is often created in real time by the show host or by live callers. Such a design presents a unique challenge to political fact-checkers since often there is no permanent record of the broadcast or its audio transcripts.

In the United States, these features take on heightened significance. Radio serves as a vital link across diverse urban and rural landscapes, functioning as a primary information source in remote areas and during long drives.

Media exposure, especially through radio, plays a crucial role in shaping political attitudes by both reinforcing and challenging existing beliefs. Theories of opinion formation suggest competing media messages intensity is crucial in explaining changes in opinions over time (see Chong, D., et al., j. Comm. 2007; Zaller, J., Cambridge University, 1992). While partisan news tends to modestly reinforce existing beliefs, it is also shown to activate and convert individuals when they are continually exposed to opposing viewpoints, leading them to shift away from their original affiliations and preferences (see Dilliplane, S., et al., Amer. j. pol. sci., 2014). Resistance to these opposing viewpoints requires the ability and motivation to recognize discrepancies between the message and one's values and beliefs (see Zaller, J., Cambridge University, 1992).

The deregulation and livestreaming of talk radio content over the Web have contributed to its rise and the corresponding increase in conservative public opinion (see Berry, J. M., et al., Ps: political science & politics, 2011). Researchers have found that exposure to talk radio can be more powerful predictor of attitudes than political knowledge (see Lee, G., et al., Pol. Comm., 2001) with information received via news radio strongly influencing policy beliefs (see Tesler, M., Pol. Comm., 2018) and promoting memory-based political information processing more effectively than entertainment media (see Kim, Y. M., et al., j. Comm., 2008).

Thus, there is a need in the art for an end-to-end system for real-time acquisition, transcription, speaker diarization, curation, and content analysis of up to several hundreds of radio live streams sourced from URLs accessible via the Web.

### SUMMARY OF THE INVENTION

Some embodiments of the invention disclosed herein are set forth below, and any combination of these embodiments (or portions thereof) may be made to define another embodiment.

In one aspect, the method disclosed herein may include identifying speaker sentiment from a live media broadcast comprising obtaining, with a radio streamer module, an audio stream of a live media broadcast, the audio stream comprising at least one speech source, splitting the audio stream into a set of fixed-length audio files, transcribing each of the set of fixed-length audio files to obtain calculated text data of content of the at least one speech source, and calculating a sentiment from the speech waveform and the calculated text data.

In one aspect, the method disclosed herein may further comprise storing the calculated sentiment and the calculated text data in a database on a non-transitory computer-readable medium.

In one aspect, the method disclosed herein may further comprise storing the at least one speech waveform in the database.

In one aspect, the at least one speech source may comprise a plurality of speech sources and the method disclosed herein may further comprise the step of assigning a unique speaker identifier to each fixed length audio file in the set of fixed length audio files.

In one aspect, the method disclosed herein may further comprise storing the calculated text data of each fixed-length audio file in the audio stream to a vector of transcription data structures.

In one aspect, each transcription data structure may comprise the calculated text data, a speaker identifier, a start time index, and a stop time index.

In one aspect, the fixed-length audio files may overlap one another.

In one aspect, the method disclosed herein may further comprise calculating a further set of sentiments from a plurality of live media broadcasts in a geographic vicinity of the live media broadcast and calculating a media sentiment for the geographic vicinity from the linguistic context and the further set of linguistic contexts.

In one aspect, the sentiment may be calculated from the speech waveform less than one minute after the audio stream is obtained

In one aspect, the method disclosed herein may further comprise translating the calculated text data from a first language to a second language.

In one aspect, the method disclosed herein may further comprise querying at least one fact-checking database with the calculated text, obtaining at least one fact-checking entry from the fact-checking database related to the calculated text, and calculating an accuracy score of the calculated text based on the content of the fact-checking entry.

In one aspect, the system may comprise a non-transitory computer-readable storage medium with instructions stored thereon, which when executed by a processor, may perform steps that comprise obtaining an audio stream of a live media broadcast, the audio stream comprising at least one speech source splitting the audio stream into a set of fixed-length audio files transcribing each of the set of fixed-length audio files to obtain calculated text data of content of the at least one speech source, and calculating a sentiment from the speech waveform and the calculated text data.

In one aspect, the instructions may further comprise storing the calculated sentiment and the calculated text data in a database on the non-transitory computer-readable medium.

In one aspect, the instructions may further comprise storing the fixed-length audio files on the non-transitory computer-readable medium.

In one aspect, the instructions may further comprise storing multiple copies of each of the set of fixed length audio files on the non-transitory computer readable medium, and analyzing each of the set of fixed length audio files in parallel with multiple processes by accessing different copies of each fixed length audio file.

In one aspect, the instructions may further comprise displaying a graphical user interface (GUI) for a user and the graphical user interface may comprise the calculated sentiment and a geographical representation of a location of a source of the live media broadcast.

In one aspect, the instructions may further comprise obtaining a set of audio streams of live media broadcasts, performing the splitting, transcribing, and calculating sentiment steps on each of the set of audio streams, and displaying, on the graphical user interface, a geographic visualization of calculated sentiment showing the location of each live media broadcast.

In one aspect, the audio stream of the live media broadcast may be obtained via an Internet radio stream.

In one aspect, the system may further comprise a radiofrequency antenna and tuner communicatively connected to the processor, wherein the audio stream of the live media broadcast is obtained from the tuner.

In one aspect, the instructions may further comprise storing the calculated text data of each fixed-length audio file in the audio stream to a vector of transcription data structures.

### BRIEF DESCRIPTION OF THE DRAWINGS

The foregoing purposes and features, as well as other purposes and features, will become apparent with reference to the description and accompanying figures below, which are included to provide an understanding of the invention and constitute a part of the specification, in which like numerals represent like elements.

FIG. 1 is a schematic of an embodiment of the system disclosed herein.

FIG. 2 depicts radio coverage in the US for AM/FM stations used in an embodiment of the present disclosure.

FIG. 3 is a depiction of an embodiment of the present disclosure wherein audio content is classified.

FIG. 4A depicts data collected in one embodiment of the system disclosed herein, wherein the data collected is neutral reporting.

FIG. 4B depicts data collected in one embodiment of the system disclosed herein, wherein the data collected is debunking reporting.

FIG. 4C depicts data collected in one embodiment of the system disclosed herein, wherein the data collected is promoting reporting.

FIG. 5 depicts the syndication of social networks among radio.

FIG. 6 depicts national polling averages from July through October 2024.

FIG. 7 is an embodiment of the system in the present disclosure depicted as state-wise normalized sentiment towards political aspirants.

FIG. 8 is a depiction of an embodiment of the CRON schedule in the data collection pipeline.

FIG. 9 is a graph of count of radio stations over time.

FIG. 10 is a bar graph showing the number of radio stations in a given format.

FIG. 11 is a graph of number of mentions and a graph of positive sentiment relating to Ozempic.

FIG. 12 is a map of the USA with state and county boundaries including radio station markers according to their precise coordinates.

FIG. 13 is a geographical representation of the political sentiment measured by the system disclosed herein.

FIG. 14 is a graph of political sentiment for a subset of parties and candidates, as derived by the system disclosed herein.

FIG. 15 is a graph of the frequency of sentiment occurrences for the two major political parties over specified date ranges, as derived by the system disclosed herein.

FIG. 16 is a graph of the frequency of sentiment occurrences for the major party candidates over specified date ranges, as derived by the system disclosed herein.

FIG. 17 is a graph of the frequency of all fact-checking rulings, as derived by the system disclosed herein.

FIG. 18 is a word cloud generated by one embodiment of the system disclosed herein.

FIG. 19 is an exemplary json string comprising information about news articles and fact checking information.

FIG. 20 is a word cloud generated by one embodiment of the system disclosed herein.

FIG. 21A and FIG. 21B are word clouds generated by one embodiment of the system disclosed herein.

FIG. 22 is a computing device which may be used with the systems and methods disclosed herein.

### DETAILED DESCRIPTION

It is to be understood that the figures and descriptions of the present invention have been simplified to illustrate elements that are relevant for a clear understanding of the present invention while eliminating, for the purpose of clarity, many other elements found in related systems and methods. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, exemplary methods and materials are described.

As used herein, each of the following terms has the meaning associated with it in this section.

The articles “a” and “an” are used herein to refer to one or to more than one (i.e., to at least one) of the grammatical object of the article. By way of example, “an element” means one element or more than one element.

“About” as used herein when referring to a measurable value such as an amount, a temporal duration, and the like, is meant to encompass variations of ±20%, ±10%, ±5%, ±1%, and ±0.1% from the specified value, as such variations are appropriate.

Throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, 6 and any whole and partial increments therebetween. This applies regardless of the breadth of the range.

In some aspects of the present invention, software executing the instructions provided herein may be stored on a non-transitory computer-readable medium, wherein the software performs some or all of the steps of the present invention when executed on a processor.

Aspects of the invention relate to algorithms executed in computer software. Though certain embodiments may be described as written in particular programming languages, or executed on particular operating systems or computing platforms, it is understood that the system and method of the present invention is not limited to any particular computing language, platform, or combination thereof. Software executing the algorithms described herein may be written in any programming language known in the art, compiled or interpreted, including but not limited to C, C++, C#, Objective-C, Java, JavaScript, MATLAB, Python, PHP, Perl, Ruby, or Visual Basic. It is further understood that elements of the present invention may be executed on any acceptable computing platform, including but not limited to a server, a cloud instance, a workstation, a thin client, a mobile device, an embedded microcontroller, a television, or any other suitable computing device known in the art.

Parts of this invention are described as software running on a computing device. Though software described herein may be disclosed as operating on one particular computing device (e.g. a dedicated server or a workstation), it is understood in the art that software is intrinsically portable and that most software running on a dedicated server may also be run, for the purposes of the present invention, on any of a wide range of devices including desktop or mobile devices, laptops, tablets, smartphones, watches, wearable electronics or other wireless digital/cellular phones, televisions, cloud instances, embedded microcontrollers, thin client devices, or any other suitable computing device known in the art.

Similarly, parts of this invention are described as communicating over a variety of wireless or wired computer networks. For the purposes of this invention, the words “network”, “networked”, and “networking” are understood to encompass wired Ethernet, fiber optic connections, wireless connections including any of the various 802.11 standards, cellular WAN infrastructures such as 3G, 4G/LTE, or 5G networks, Bluetooth®, Bluetooth® Low Energy (BLE) or Zigbee® communication links, or any other method by which one electronic device is capable of communicating with another. In some embodiments, elements of the networked portion of the invention may be implemented over a Virtual Private Network (VPN).

The present disclosure provides an end-to-end system for real-time acquisition, transcription, speaker diarization, curation, and content analysis of up to several hundreds of radio live streams sourced from URLs accessible via the Web. In some embodiments, some or all system components rely on AI tools such as multimodal large language models (LLMs). This foundation enables rapid design and deployment and showcases AI's potential as a valuable tool for worldwide broadcast media analysis.

In one embodiment, the present disclosure produces a comprehensive, segmented record of radio content, categorized into mutually exclusive, chronologically ordered, speaker-tagged, chat-like transcripts. This approach preserves the temporal integrity of the original broadcast, clearly delineating transitions between political discourse, advertisements, and apolitical content. Consequently, users can navigate the transcribed content with a clear understanding of its structure and context, even when encountering interruptions such as advertisements within political discussions.

Producing the segmented and categorized records of audio content from live streams is, in one embodiment, processed through several technical components and analytic algorithms. In some aspects, the component makeup of the system in the present disclosure comprises a radio streamer, an audio processor, and a processor configured to perform political messaging and sentiment analytics on collected audio data.

In some embodiments, the radio streamer comprises an audio stream collection component. The audio stream collection component may, in some aspects, collect audio streams by recording audio streams from an AM, FM, or Satellite radio received, or by recording digital audio streams for example available on the Internet.

Conventionally, radio stations are referred to by their call signs (3-4 lettered string) with the starting letter being either W (Stations east of the Mississippi River), K (Stations west of the may further comprise a processor configured to find, stream, and record multiple audio broadcasts in parallel. Further, in some embodiments, the radio streamer 101 takes as input a configurable schedule in the form of a JSON file. The configurable schedule may be configured by a user or may update automatically based on information received from one or more connected servers.

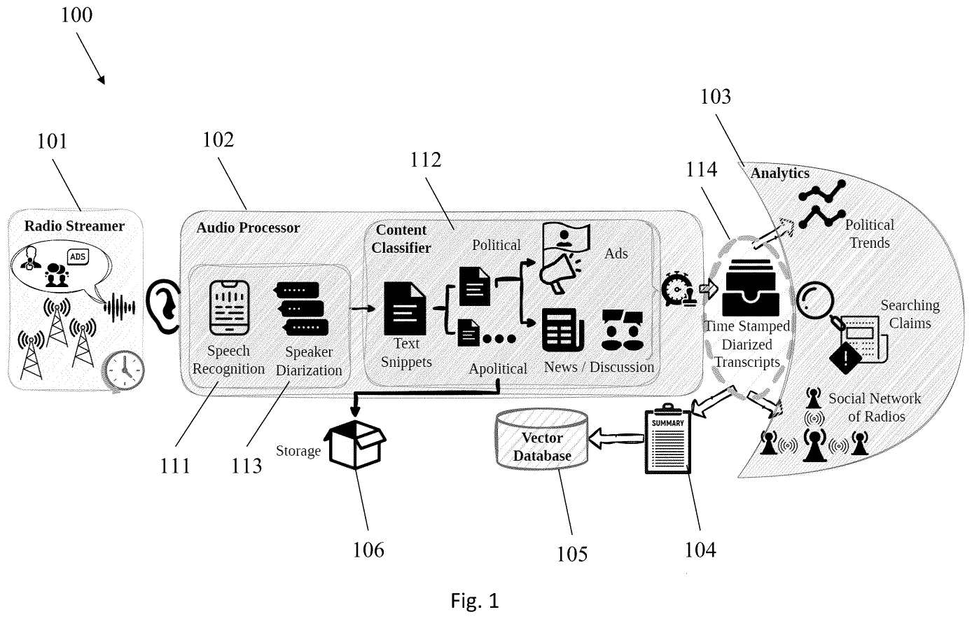

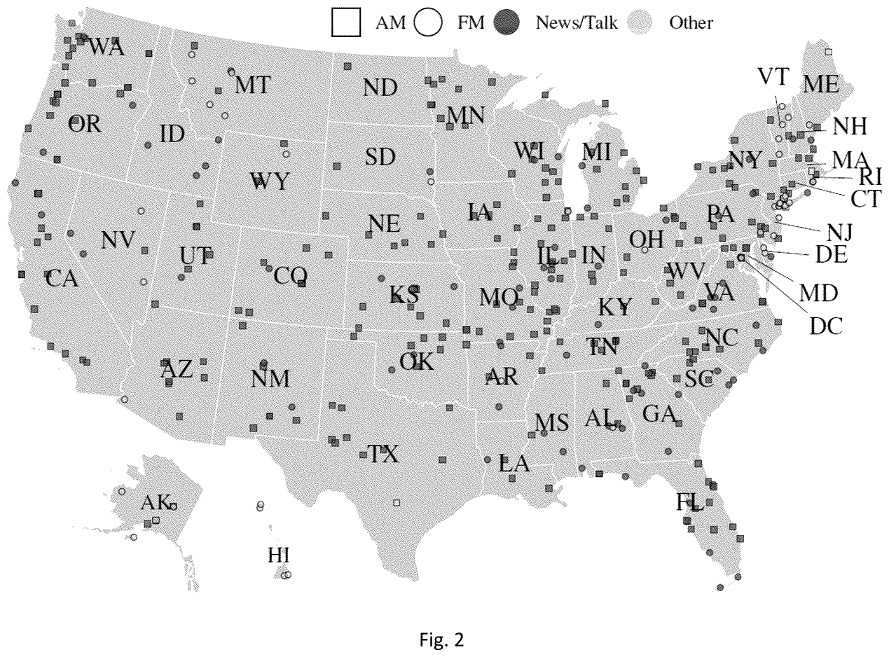

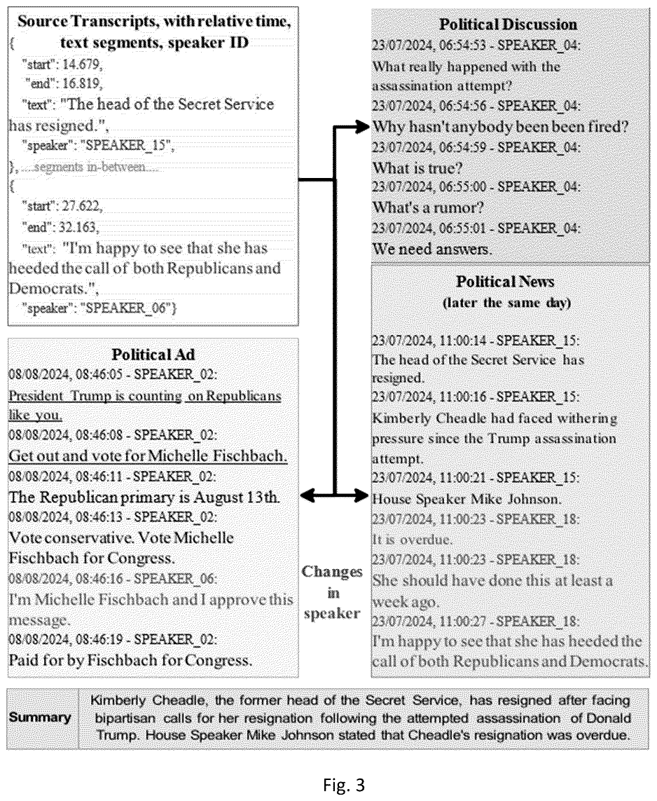

With further reference to FIG. 1, the radio streamer 101 may comprise any number of audio inputs or audio input mechanisms, including but not limited to an AM radio tuner, an FM radio tuner, a satellite radio receiver, a HAM radio receiver, digital television receiver, satellite television receiver, or a software configured to record or download from one or more digital audio or audio-visual streams, for example digital broadcast streams. In some embodiments, the radio streamer 101 may comprise a software configured to standardize audio streams recorded or received in different formats, for example by converting audio files to a consistent file type, bit rate, sampling rate, etc. In some embodiments, the radio streamer 101 may comprise one or more audio encoders or decoders, for example configured to convert and store one or more audio streams as MP3, WAV, FLAC, AAC, RAW, Ogg Vorbis, or any other suitable audio format. In some embodiments, a radio streamer 101 may save space by converting a stereo recording to a mono recording, and/or by lowering a bitrate or sampling frequency of a recording.

The audio processor 102 may in some embodiments comprise a speech-to-text transcription module 111 and a content classifier 112. The transcription module 111 may be configured to receive as an input audio files or audio data produced by the radio streamer 101 and transcribe the audio to text. In some embodiments, the transcription module 111 may further comprise a speaker diarization module 113 configured to recognize, group, and/or label text that was uttered by the same speaker in an audio file or audio data stream. The audio processor 102 may therefore in some embodiments produce as an output a text-based data structure comprising a diarized transcription or transcript 114 of an audio stream.

The content classifier 112 may take as an input the text-based data structure returned by the transcription module 111. The content classifier may then analyze the text and categorize different passages of the text-based data structure as different types of audio. For example, a content classifier may label or tag one or more sections of the text as music, speech, political speech, non-political speech, banter, news/discussion, advertisements, laughter, etc. In some embodiments, a content classifier 112 may differentiate between recorded advertisements and advertising copy read by the on-air personalities. The audio processor 102 may therefore provide as an output a text-based, diarized and timestamped transcript 114 comprising a textual representation of what was said during the audio stream, comprising for example names or designators for the various speakers, and tags denoting what type of speech each utterance was. The transcript 114 may then be stored as a summary 104, for example in a database 105 that may be a vector database.

In some embodiments, the audio processor 102 is responsible for transcription, adding punctuation and capitalization to the text, providing time stamps to the transcript, and diarizing the audio content.

In some embodiments, the speech recognition module 111 and speaker diarization module 113 may implement an automatic speech recognition (ASR) model for transcription. The ASR model may be designed and coded to analyze audio input, break it down into smaller segments, and then predict the most likely text transcription for each segment. Further, the ASR model maybe capable of analyzing English, or the ASR model may by capable of analyzing audio content of a homogenous non-English audio content. In some embodiments, the ASR model may analyze and transcribe an audio stream and/or broadcast that contains multilingual audio data, for example English and Spanish speakers, or any language.

The ASR model may comprise an encoder-decoder transformer architecture. To further increase accuracy, the ASR model may use weakly supervised learning, in which the ASR model automatically learns and adapts to diverse accents and speech patterns. Further, accuracy in transcription outputs may be improved by instructing the ASR model to automatically segment audio source recordings up to 30 minutes in duration, or any duration ranging between 1 second and 500 minutes.

The diarized transcript 113 may further be provided to an analytics engine 103, which may further analyze all or a subset of the transcript for various speech trends or characteristics, and may assign further parameters to segments of the speech based on the calculated trends or characteristics. Characteristics which may be analyzed include, but are not limited to, political trends, factual claims, candidate support, product endorsement, sports trends including the number of individual team and/or player mentions, sentiment analysis related to any of the analyzed characteristics, business trends including the number of individual businesspeople and/or organizations mentioned, and sentiment analysis related to a particular individual or product.

In some embodiments, the radio streamer 101 may further accept as an input a data structure comprising further information about certain audio broadcasts, for example including at least one of a program start time, a program end time, a radio station identifier, a radio station URL, a program name for the broadcast audio content, the duration of the program, and/or the state from which the broadcast originated. In some embodiments, a configurable schedule may comprise a set of instructions executable by a processor instructing the radio streamer to perform the finding, streaming, and recording steps outlined above. In some embodiments, once the configurable schedule is ready to implement, a processor configured to execute the instructions processes the schedule to get unique start times across all the stations and durations specific for each station. A scheduled unattended task, for example a CRON job, may then be created and stored for each objective of the radio streamer 101, including a CRON job that executes transcription in the audio processor in parallel with streaming and recording audio broadcast by the radio streamer. In some embodiments, a system as shown in FIG. 1 may create one or more buffer folders to enable parallel processing of audio streams, thus improving the efficiency of this field of technical endeavor.

In some embodiments, the system in the present disclosure may record and save audio files in chunks of a fixed or variable duration, for example a duration of 1 minute, 2 minutes, 3 minutes, 4 minutes, 5 minutes, 10 minutes, 15 minutes, 20 minutes, 30 minutes, 40 minutes, 50 minutes, 60 minutes, or any value between 1-60 minutes, 5-45 minutes, 20-40 minutes, or about 30 minutes. Saving the audio as fixed-time chunks may in some embodiments improve transcription and analysis. The recorded and saved audio files may be distributed into buffer folders, and in some embodiments multiple copies of a saved audio file may be created to allow for multiple processing threads to analyze the same audio data in parallel. Copies may be created on non-transitory memory, for example a disk or flash memory, or alternatively copies may be created in random access memory (RAM). Distributing the files into buffer folders improves the transcription process and allows for parallel transcription. Further, a plurality of GPUs may be electrically connected to the system of the present disclosure. Buffer folders may be created based on the number of available GPUs in the system of the present disclosure to run transcription.

Further, one or more types of buffer folders may be created. In some embodiments, a local buffer folder is created and assigned to a radio stream. The radio stream's audio content is then streamed and recorded by the radio streamer. This recording is placed on readable memory in the audio recordings module. The audio recordings module transfers the radio stream's recording information to a local audio buffer module. An audio recording CRON trigger is engineered to automatically save and remove audio recordings categorized as non-political discourse or advertisements from the analysis pipeline. In one embodiment, files are named in a format wherein the filename comprises information about the audio stream. In one embodiment, a file naming scheme used is SS_RRRR_yyyy_mm_dd_HH MM.mp3 where SS is the two-letter state abbreviation, R is the four-character radio call-sign which is unique for each radio station, followed by year, month, day, hour and minute. An example file name is CA_KAHI_2024_07_16_13_30.mp3, which would correspond to an audio recording taken from California stations KAHI on Jul. 16, 2024 at 1:30 pm. In some embodiments, the time used is local time at the radio station, whereas in other embodiments, the time may be a fixed timezone used throughout the system, for example Eastern Standard Time, Pacific Standard Time, or UTC. This naming format improves data access, thus improving computing efficiency, by providing ways to easily filter files based on state, radio station, dates, or time.

One advantage of the disclosed system is that less time is required between acquiring the audio content and diarizing the audio content. This decreased processing time allows for a novel approach to recording and analyzing real-time live streams of audio content, including but not limited to radio broadcasts, television broadcasts, podcasts, live events, and/or online video publishing platforms.

Generally, one H100 GPU takes around 30 seconds to generate a diarized transcript for one audio file 30 minutes in length. This means that in the time it takes to acquire a new 30-minute audio file, one GPU can process 60 audio files each 30 minutes in length. This in turn means that one GPU can process 60 radio streams simultaneously without creating any backlog. In one embodiment, the system in the present disclosure may comprise a plurality of GPUs. In some embodiments, the system of the present disclosure may include enough GPUs to process 400+ streams. In some aspects, the system of the present disclosures may comprise seven H100 GPUs. Although certain embodiments disclosed herein may be discussed in the context of a particular GPU, for example an H100 GPU, it is understood that one or more other types of GPU may be used, including but not limited to A100, L40, and RTX4090. Due to resource constraints in local servers, some embodiments may comprise a cloud service provider configured to provide access to one or more additional remote GPUs to process all the audio streams. In one embodiment, a subset of the system runs on a local server, wherein the subset of the system may only comprise the radio streamer 101. The subset of the system therefore may only record the streams and store audio files in a recordings folder on the local server and copies may further be stored in one or more audio buffer folders. In one embodiment, a first buffer CRON trigger may be configured to periodically transfer files from one or more audio buffer folders to one or more high performance computing (HPC) audio buffer folders. A second buffer CRON trigger may then be configured to automatically and periodically transfer files from one or more HPC audio buffer folders to one or more audio buffer folders of the cloud computing service. The audio processor 102 and analytics engine 103 may then be executed on the cloud computing service. In other embodiments, files in the recordings folder are sent to backup folders regularly, and the recording files stored in the one or more audio buffer folders may be used for transcription and then deleted once transcribed.

In another embodiment, the system may comprise a cloud server. The cloud server may further comprise one or more GPUs, for example H100 GPUs, programmed to at least partially transcribe the audio recording and save the partial transcription in one or more transcript folders. A third audio CRON trigger may then be configured to automatically transfer files from one or more transcripts folders on the cloud server to the local server. Audio streams with less data, for example audio streams with large gaps of silence or music, may be processed by the local server. In some embodiments, after local server processing, both recording and transcription files may be enabled on the local server, thereby eliminating the need to use cloud resources and create data pipelines.

In some embodiments, the system may comprise a summarization module. The summarization module is configured to execute a summarization process. In some embodiments, the summarization process condenses lengthy conversation transcripts into concise, meaningful summaries. In some embodiments, the system processes audio recording files and transcription files through a second convolutional neural network. Further still, in some embodiments, audio content is segmented into 30-minute transcripts. In some embodiments, the disclosed system may comprise one or more convolutional neural networks (CNN) that employ a transformer architecture and may tokenize audio data into a sequence of tokens. Tokenization allows the system to analyze information at a granular level. Pertinent information may include the classification of audio data content as either political, non-political, or advertisements.

In some embodiments, a summarization module may comprise the use of a large language model created with a summarization prompt. Examples of summarization prompts are provided below:

Summarization Prompt 1: You are a concise and direct news summarizer. Given below is a JSON with spoken text and its speaker ID recorded from a radio livestream. Create a summary that:

Presents information directly, without phrases like “I heard” or “The news reported.” Uses a factual, journalistic tone as if directly reporting the news.

Retains key facts and information while making the content specific and granular.

Removes personal identifiable information (PII), such as phone numbers and sensitive personal data, but keeps public figures' names (e.g., politicians, celebrities) and other key proper nouns relevant to the context.

Is clear and avoids vague language.

Clarifies ambiguous words or phrases.

Utilizes changes in speaker ID to understand the flow of conversation or different segments of news.

Corresponds strictly to information derived from the provided text.

Organizes information into coherent paragraphs, each focusing on a distinct topic or news item.

Maintains a neutral, objective tone throughout the summary.

Do not include any meta-commentary about the summarization process or the source of the information.

### Spoken Text Transcription: {Conversation Block}

Summarization Prompt 2: Analyze the following document summary regarding mentions of the 2020 election being stolen, rigged, or false.

Document summary: {content} Answer the following questions:

How many times was the 2020 election being stolen, rigged, or false mentioned?

Did the document promote, neutral report, or debunk these claims?

Provide your answer in the following format: “mention_count”: <number of mentions>, “stance”: <promote/neutral/debunk>

### Spoken Text Transcription: {Conversation Block}

In some embodiments, the conversation segments are generated and summarized, and embeddings are created for each summary. These embeddings serve as high-dimensional vector representations that capture the semantic meaning of the text. The embeddings are generated using a multi-lingual, multi-functional, multi-granularity embedding model. By converting textual summaries into vectors, the system in the present disclosure may perform operations such as similarity comparisons, clustering, and semantic search more efficiently.

The embedding function, denoted by f, transforms a given summary S into a high-dimensional vector v∈Rd, where d represents the number of dimensions in the vector space. The process can be mathematically described as:

vₛ=f(S),f: [symbol] → [symbol] Equation 1

Here, S is the summary, vₛ is its corresponding embedding, n is the number of words in the summary, and d is the dimensionality of the embedding space. This transformation allows each summary to be represented as a vector, which can then be compared against other vectors in terms of cosine similarity or other distance measures.

To compare the semantic similarity between two summary embeddings, cosine similarity is used. The cosine similarity between two vectors vᵢ and vⱼ, representing summaries Sᵢ and Sⱼ, is given by:

$$Cosine Similarity ( {v}_{i} , {v}_{j} ) = \frac{{v}_{i} \cdot {v}_{j}}{‖ {v}_{i} ‖ ‖ {v}_{j} ‖} \qquad Equation 2$$

where vᵢ·vⱼ represents the dot product of the vectors, and ∥vᵢ∥ and ∥vⱼ∥ are the magnitudes (or norms) of the vectors. The similarity measure is particularly useful for clustering, retrieval, and semantic search tasks.

Given the large number of summaries, the embeddings are generated asynchronously to improve performance and scalability. By parallelizing the generation process, a notable reduction in processing time may be observed. This ensures that embeddings are computed efficiently for each summary.

In some embodiments, the embedding function may be queried asynchronously for each summary. By leveraging the embeddings, each summary is represented in a vector space, allowing for more advanced semantic operations. The generated embeddings may then be used for multiple downstream tasks. Examples of downstream tasks included at least one of clustering, retrieval, and/or semantic searching. Clustering is described as grouping similar conversations based on their semantic embedding. Retrieval describes efficiently finding summaries that are similar to a given query. Semantic search refers to searching through conversation summaries based on the semantic content rather than exact matches.

In some embodiments, the system of the present disclosure may employ an AI Similarity Search (AISS), for example Facebook AI Similarity Search. The AISS is employed to perform efficient nearest-neighbor searches in high-dimensional vector spaces. Given the many summaries in the system disclosed herein, AISS provides scalability for searching through embeddings. The AISS workflow consists of the following steps:

Step 1: initialize an AISS index with the appropriate dimension size, d, where d is the size of the embedding vectors. The AISS index is initialized as

AISS Index=faiss·IndexFlatL2(d) Equation 3
where d is the dimension of the embedding vectors. A similarity search may then be performed by querying the index with the query embedding q.

Step 2: add the embeddings for each summary to the index.

Step 3: perform nearest-neighbor search queries on the index to find semantically similar summaries.

Distances,Indices=FAISS Index·search(q,k) Equation 4
where k is the number of nearest neighbors to retrieve.

Analysis of transcripts revealed that the same narrative, content, or show was often broadcast multiple times on a radio station and across multiple stations, even when the stations appeared independent. An algorithm was developed to identify unique narratives that were shared multiple times and form a network of radio stations for each narrative. MinHash, with a similarity threshold of 0.8, was used to check if any two transcripts contained the same content. This process identified approximately 22,000 unique narratives from the dataset.

Output Summary of Common Content: This collection of text excerpts focuses on the upcoming US presidential election and the role of celebrities in influencing voters. Election Coverage:

The Democratic National Convention concluded with Vice President Kamala Harris accepting the party's nomination for president.

The convention featured speeches from prominent Democrats and celebrities, highlighting their support for the Harris-Biden ticket.

The election is just two months away, with the first presidential debate scheduled for September 10th.

### Celebrity Endorsements:

Celebrities are increasingly using their platforms to endorse political candidates.

While some celebrities, like Oprah Winfrey, have been shown to have a significant impact on voter turnout, others, like Taylor Swift, have not yet endorsed anyone.

The rise of social media and AI-generated images has created new challenges for verifying the authenticity of celebrity endorsements.

### Other Topics:

The text also includes information on the economy, specifically the role of data-driven decision-making in various industries.

The text also touches on the importance of free speech and the potential risks of “cancel culture.”

In some embodiments, an algorithm may be employed to find unique narratives in broadcasts. In some embodiments, the algorithm is as follows:

Algorithm 1 Finding unique narratives in broadcasts
Require: Set of radio broadcast transcripts T = {t₁, t₂, ..., tₙ}
Require: Similarity threshold θ
Require: Time threshold Δt
1: function OptimizedAnalyzeBroadcasts(T, θ, Δt)
2: H ← ComputeLSH(T) [symbol] Compute LSH for all transcripts
3: A ← CreateAdjacencyList(T, H, θ)
4: N ← Identify NarrativesDisjointSet(A)
5: return N
6: end function
7: function CreateAdjacencyList(T, H, θ)
8: A ← empty dictionary
9: for each tᵢ ∈ T do
10: C ← GetCandidates(H, tᵢ ) [symbol] candidates from LSH
11: for each tⱼ ∈ C do
12: if MinHashSimilarity(tᵢ, tⱼ ) ≥ θ then
13: A[tᵢ] ← A[tᵢ] ∪ {tⱼ} [symbol] add to matching set
14: A[tⱼ] ← A[tⱼ] ∪ {tᵢ} [symbol] maintain symmetric set
15: end if
16: end for
17: end for
18: return A
19: end function
20: function Identify NarrativesDisjointSet(A)
21: N ← Ø [symbol] Set of disjoint repeated narratives
22: V ← Ø [symbol] Set of visited nodes
23: for each t ∈ A.Keys not in V do
24: n ← BFS(A,t,V)
25: N ← N ∪ n
26: end for
27: return N
28: end function

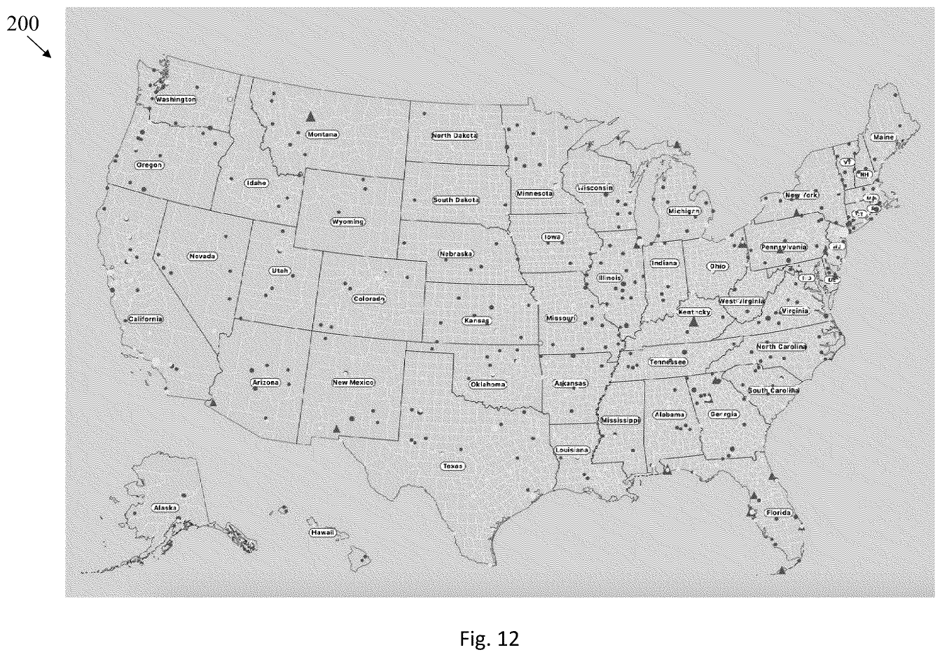

In some embodiments, system 100 comprises a user interface (UI). An exemplary UI 200, also referred to herein as a “visualization platform” and “frontend” is described herein and shown in FIGS. 12-16. In some embodiments, the system comprises a comprehensive real-time data visualization platform which may for example leverage React for the frontend and Django with PostgreSQL for the backend. In other embodiments, any relational database may be used, for example MySQL, MSSQL, NoSQL, or SQLite. The system may be designed to create an intuitive and responsive UI that facilitates data analysis and exploration.

One embodiment of the frontend, built with React, establishes communication with the backend through REST API calls, utilizing Axios for data management. To enhance performance and user experience, the frontend implements asynchronous data fetching techniques and employs caching mechanisms.

The platform comprises key components, each serving a specific purpose in the data visualization ecosystem.

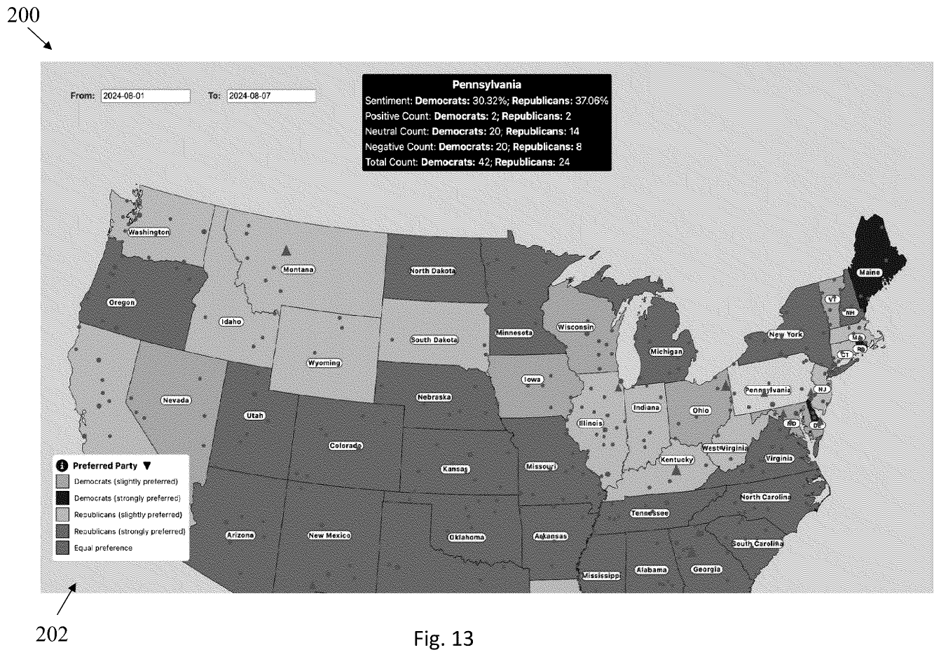

The Home Page functions as the central navigation hub for the frontend application, providing users with access to various features and data visualization options. A Map UI may be built upon the ComposableMap component from ‘react-simple-maps,’ offering users an interactive United States map. This visualization includes state boundaries, county outlines, and markers representing population centers and radio station coverage areas. Examples of map user interfaces are shown in FIG. 12 and FIG. 13.

To enhance user interaction and data analysis capabilities, the map interface offers toggles 202 and filters 204:

### Map Level Toggles

State Party Toggle: Visualizes sentiment data for political parties at the state level, providing insights into political leanings across regions.

State Candidate Toggle: Presents sentiment data for individual candidates at the state level, allowing for comparison of candidate popularity.

State Party Absolute Toggle: Displays absolute sentiment counts for political parties at the state level, offering a quantitative view of party support.

State Candidate Absolute Toggle: Shows absolute sentiment counts for candidates at the state level, enabling direct numerical comparisons.

### Coverage Toggles

Show County Toggle: Activates county-level data visualization, allowing for granular analysis of sentiment patterns.

Show Coverage Toggle: Illustrates each station's approximate radio area coverage, providing insights into broadcast reach.

Show Population Toggle: Highlights population density markers for major U.S. cities, contextualizing sentiment data with demographic information.

### Narrative Toggle

The “Georgia Election Stolen” option visualizes how information related to the 2020 Georgia election controversy propagated through the radio network, offering insights into information dissemination patterns.

### Date Picker

This feature empowers users to select specific date ranges for data visualization, enabling temporal analysis of sentiment trends and patterns.

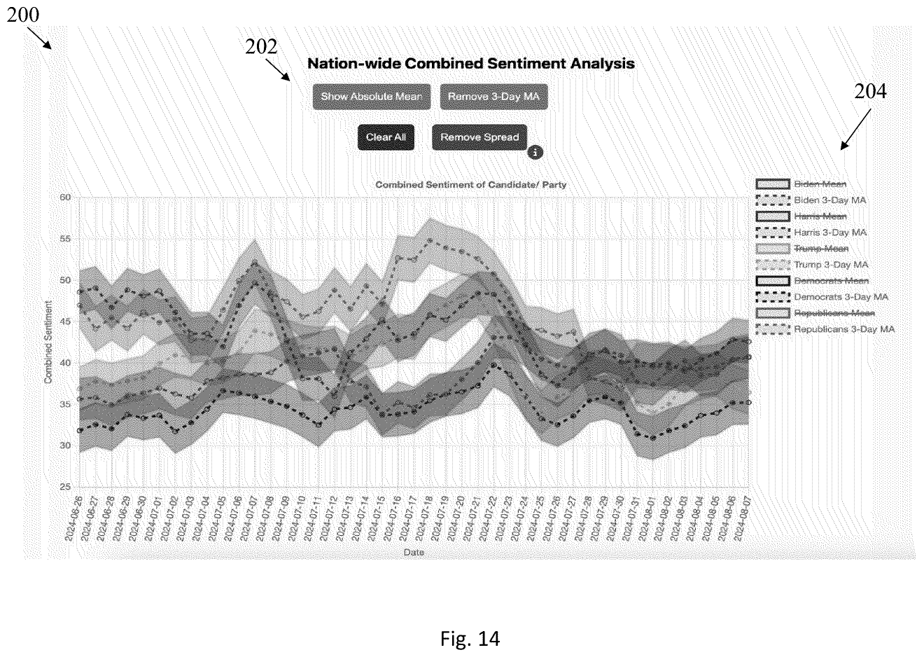

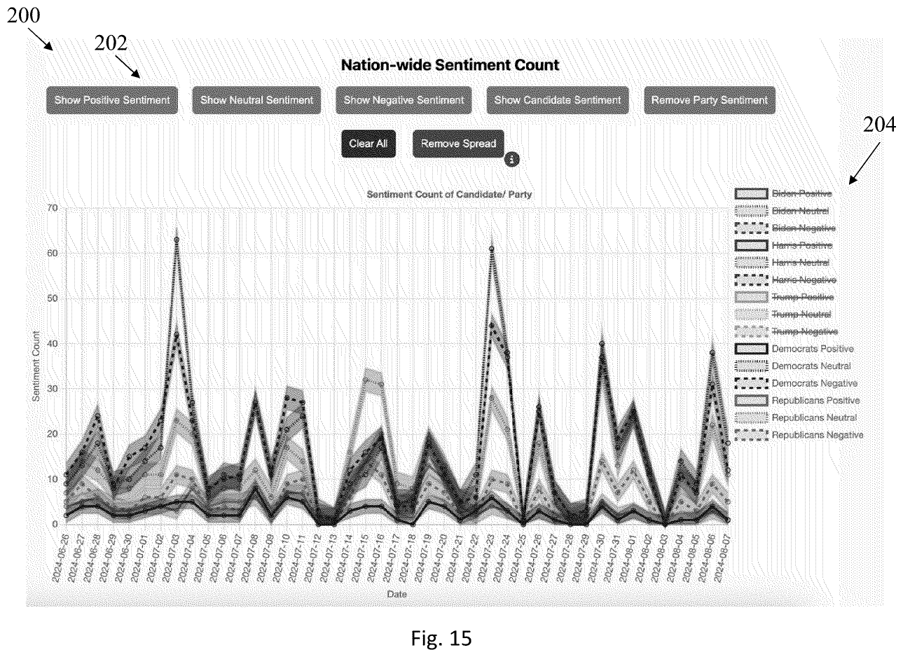

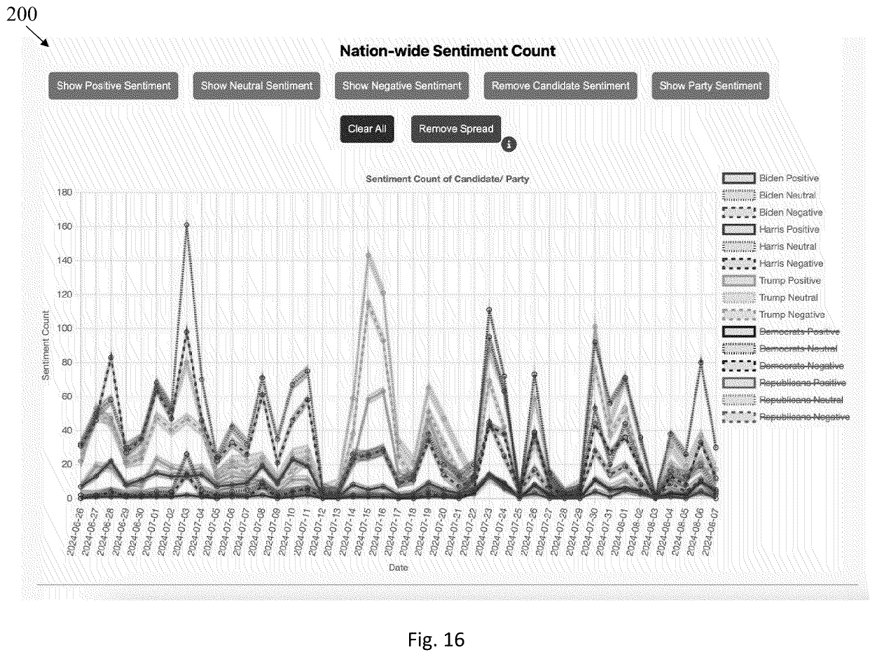

The Plots UI component features two primary line charts: a nationwide combined sentiment analysis and a nationwide sentiment count. These charts are designed to adjust based on user interactions, providing a responsive data exploration experience. To add depth to the visualizations, entropy is incorporated, providing context to the plotted data and illustrating the degree of uncertainty in the sentiment analysis. Examples of plots presented by one embodiment of a Plots UI as disclosed herein are shown in FIG. 14, FIG. 15, and FIG. 16.

The Sentiment Analysis Chart focuses on presenting sentiment values for key political entities (Biden, Harris, Trump, Democrats, and Republicans) daily. To smooth out short-term fluctuations and highlight longer-term trends, the system calculates and displays a 3-day moving average, as shown for example in FIG. 14.

The Sentiment Count chart plots sentiment counts for both candidates and political parties. Users may toggle between different data lines, allowing them to focus on positive, neutral, or negative sentiments as needed for their analysis, as shown for example in FIG. 15 and FIG. 16.

### Backend

In some embodiments, a system as disclosed herein may comprise a backend, which may expose one or more APIs facilitating interaction with the frontend. In some embodiments, a backend may use Django or another web development framework. This backend infrastructure may additionally be configured to process, aggregate, and/or format data to enable real-time visualizations. The system may further comprise a database, for example a PostgreSQL database for handling queries and storing time-series data, ensuring rapid data retrieval and analysis capabilities.

In some embodiments, the deployment process is integrated with one or more code repositories, for example GitHub repositories, facilitating a Continuous Integration/Continuous Deployment (CI/CD) pipeline. This integration allows for updates and ensures that the latest stable version of the application is available to users.

In some embodiments, a deployment pipeline may be configured to deliver pre-built assets directly to the browser, resulting in fast load times for users. This approach eliminates the need for server-side rendering, enhancing the application's responsiveness.

In some embodiments, a deployment pipeline may be configured for automated deployment, meaning that updates to the frontend trigger automatic deployment processes. This automation streamlines the development workflow and ensures that new features and improvements are available to users.

In some embodiments, a deployment pipeline may support version control, allowing for tracking of changes and rollbacks if necessary.

The backend may in some embodiments be configured to process incoming requests, manage complex business logic, and interface with the database to serve real-time data to the frontend. This setup ensures efficient data management and enables the dynamic features of the disclosed platform.

A backend as disclosed herein may support dynamic resource allocation, meaning it may be configured to adjust resource allocation based on the backend workload, ensuring optimal performance during peak usage periods.

A backend as disclosed herein may support comprehensive monitoring, for example including integrated monitoring tools configured to provide real-time insights into system performance, allowing for proactive management and optimization.

A backend as disclosed herein may be configured for streamlined deployment, including automatic deployment processes triggered by code repository pushes, ensuring that the backend remains synchronized with the latest code changes. In some embodiments, a backend as disclosed herein may comprise a development backend branch and a production backend branch to ensure stability of code deployed to the public.

In one embodiment, the system comprises a fact-checking program configured for the automated collection, processing, and post-processing of fact-checking articles from reputable websites. The fact checking system may comprise a web-scraping engine for accessing data from fact checking sites, and may further incorporate specialized spiders for specific fact-checking websites, including FactCheck.org, Lead Stories, Politifact, Snopes, and TruthOrFiction.

In some embodiments, the data collection period for a fact checking engine may fall within a fixed range, for example from Jan. 1, 2020 forward. In some embodiments, a data collection process for a fact checking engine may be configured to detect and/or exclude AI-generated content.

The web scraping engine may further be configured with various filtering options, including date range, keywords, tags, and pagination. This adaptability allows targeted data collection based on specific research needs.

Post-crawling, the system may comprise a data merging engine configured to combine information from all or a subset of scraped websites into a unified dataset. A key feature of the fact-check web crawler disclosed herein is the standardization of fact-checking rulings across different articles, ensuring consistency in the analysis. The merged dataset may undergo a filtering process to isolate political content, enabling focused studies on political misinformation.

The system may further comprise a deduplication module. The deduplication module may be configured to identify manage duplicates within the scraped data by identifying and analyzing textual content in the fact checking articles, based for example on publication date. The deduplication module therefore ensures data integrity and prevents redundancy.

The deduplication process may be configured to employ natural language processing techniques, including vectorization of TF-IDF (Term Frequency-Inverse Document Frequency). This method transforms the text into a numerical representation, enabling the calculation of cosine similarity between articles. The system clusters and manages duplicate content by setting thresholds for similarity and considering publication date proximity.

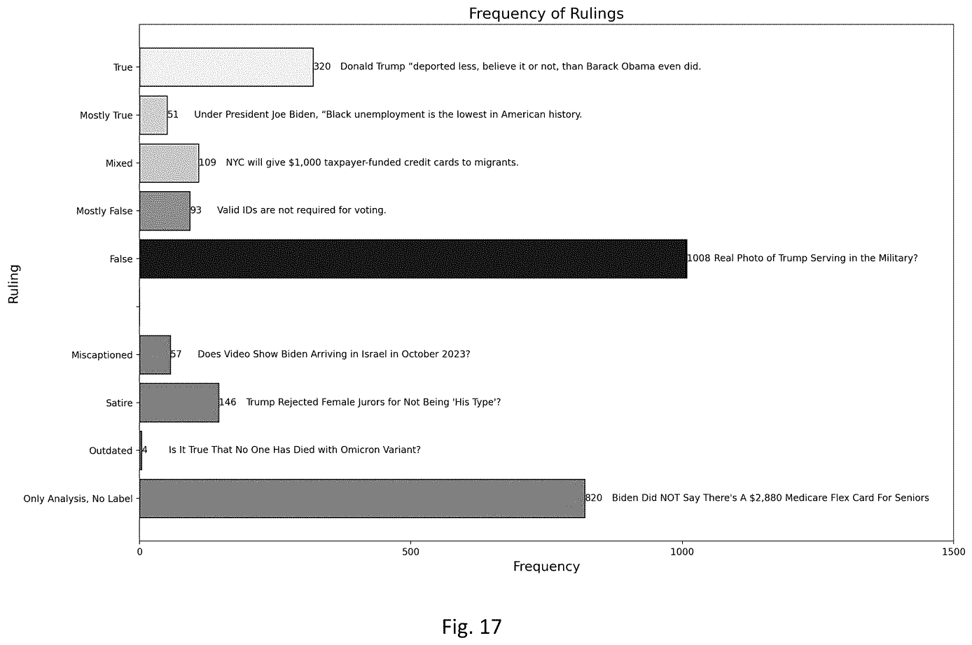

The fact checking engine may be configured to generate a histogram to visualize the frequency distribution of various fact-checking rulings. This analysis can provides insights into the landscape of misinformation and fact-checking efforts. An exemplary histogram is shown in FIG. 17.

As shown in FIG. 17, the “False” category shows the highest frequency, with 1008 instances, indicating a significant volume of debunked claims. “True” claims occur less frequently, with 320 instances suggesting a lower proportion of verified information in the fact-checking landscape overall.

Categories such as “Miscaptioned,” “Satire,” and “Outdated” constitute a notable portion of the dataset, highlighting the diverse nature of misinformation and the nuanced approach required in fact-checking.

To represent the fact-checking landscape, the analytics module may further be configured to generate one or more word clouds that visually depict the most frequent words in article titles, categorized by their fact-checking “rulings.” This approach offers insights into recurring themes and topics within different truth categories. The titles were divided into four primary categories:

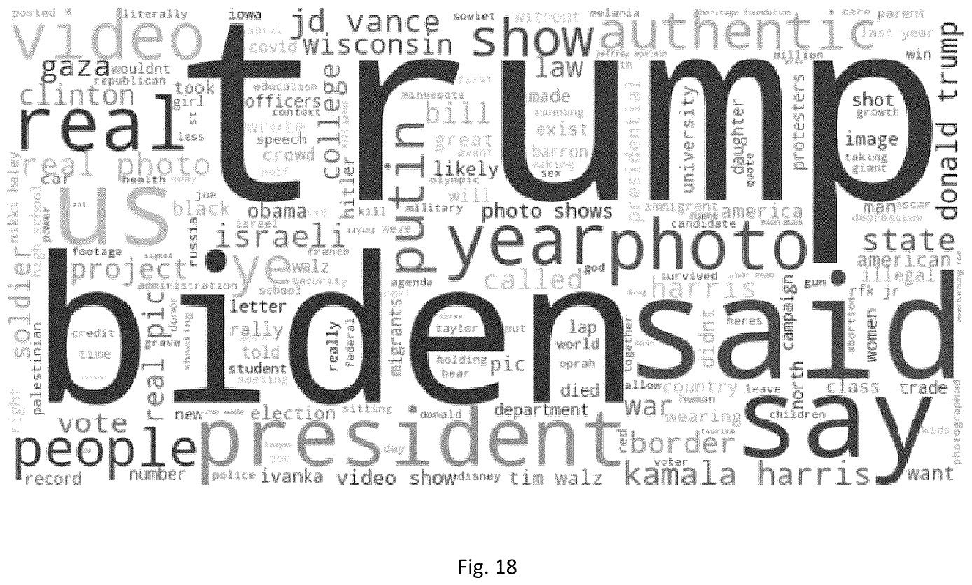

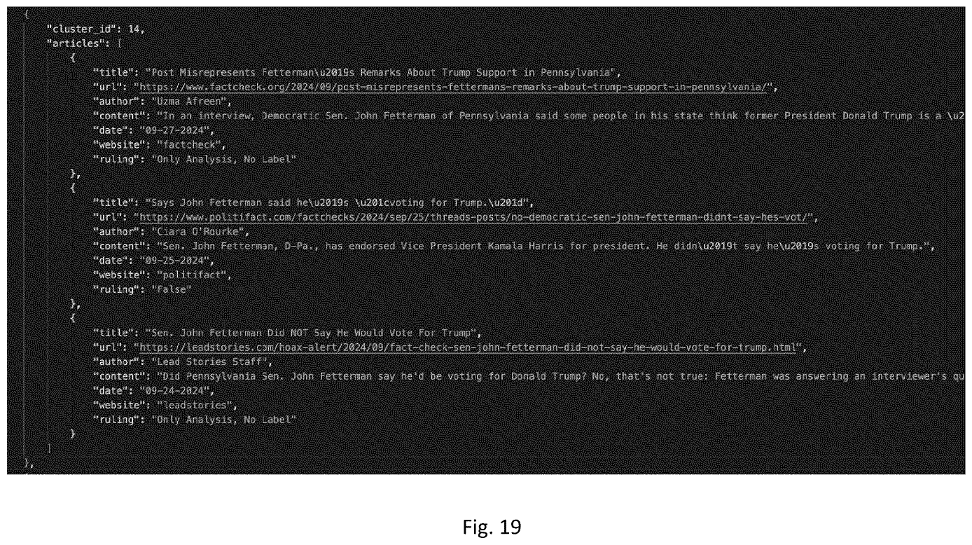

One exemplary word cloud shown in FIG. 18 shows the frequency of occurrence of significant words in fact checking articles with the ruling of “True.” Word clouds for this category often feature prominent political figures and terms related to electoral processes, such as “election,” “president,” and “vote.”

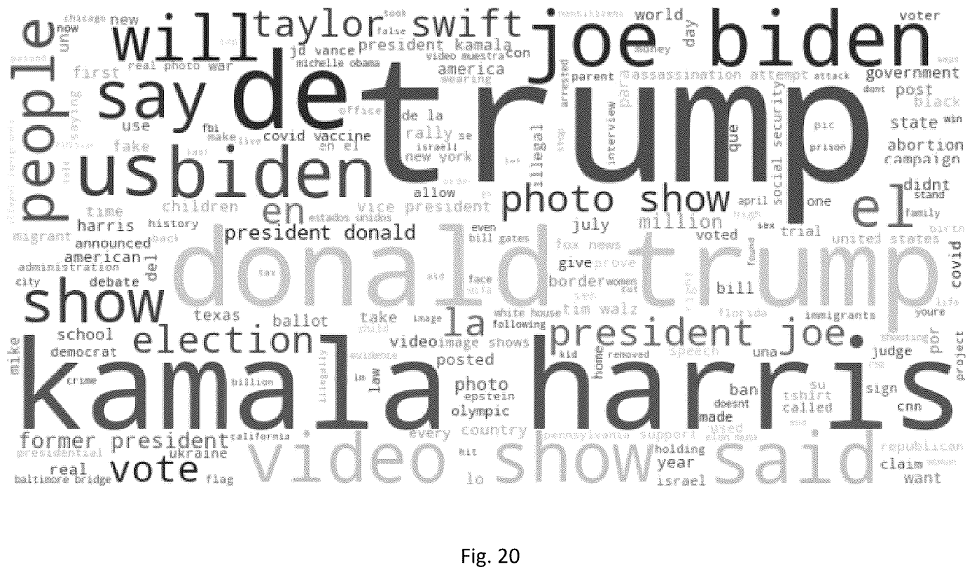

One exemplary word cloud shown in FIG. 20 shows the frequency of occurrence of significant words in fact checking articles with the ruling of “False.” While containing similar political keywords, this category notably includes terms like “photo,” “fake,” and “real,” indicating a prevalence of visual misinformation.

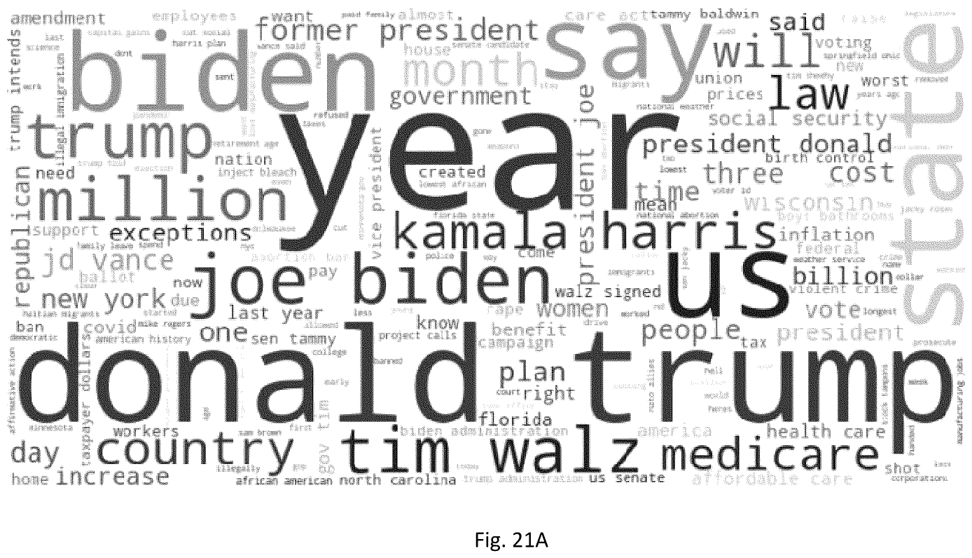

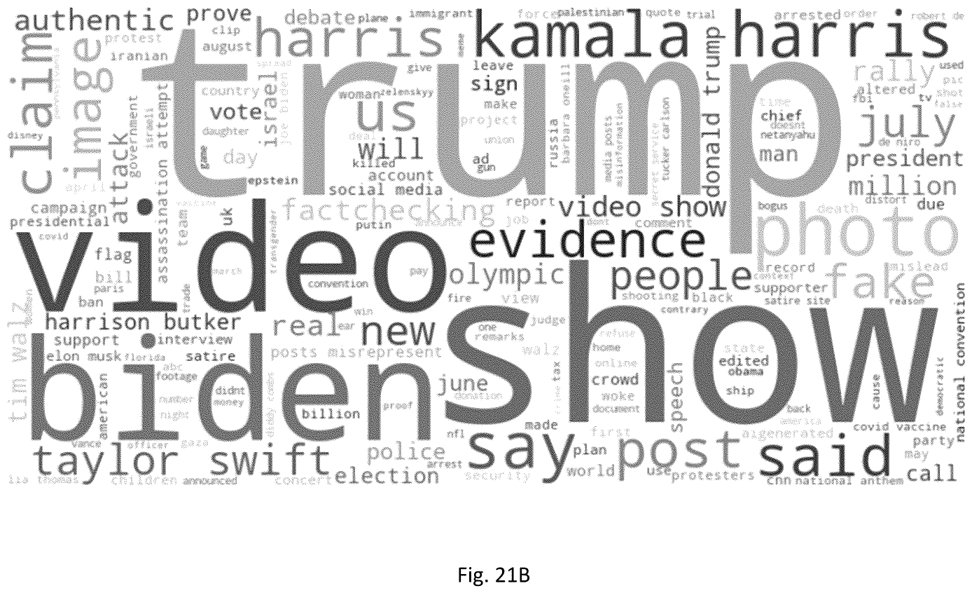

Another exemplary word cloud shown in FIG. 21A shows the frequency of occurrence of significant words in fact checking articles with a “Middle” ruling, including “Mostly True,” “Mixed,” or “Mostly False.” This category highlights words such as “year,” “million,” and “country,” suggesting a focus on claims involving statistics or demographic information.

In some embodiments, a system may further generate word clouds in a “Miscellaneous” category, which may cover remaining fact checking classifications, for example “Satire” or “Outdated.” In some embodiments, any classifiers outside the categories defined above will fall into the “Miscellaneous” category. Such word clouds may contain words such as “video,” “claim,” “fact-checking,” and “evidence” as more prominent, reflecting the complex nature of these fact-checks. FIG. 21B shows an exemplary word cloud for the Miscellaneous category.

In some embodiments, the system comprises an analysis module. The analysis module may leverage an audio processor, for example the audio processing capabilities of MediaPipe, enabling extraction and analysis of spoken content with accuracy. In some aspects, the analysis module may discriminate between speech content and non-speech content, for example music, sound effects, silence, static, etc.

In one embodiment, the process of audio segmentation begins with loading the audio file into the analysis module. Once loaded, the audio data is converted into a numpy array, allowing for manipulation and analysis. The system then employs a segmentation approach, dividing the audio into fixed-length chunks with a specified overlap between consecutive segments. This segmentation is crucial for analyzing smaller portions of the audio stream, enabling the capture of specific speech events with precision.

Overlap between segments ensures continuity and prevents the loss of important speech elements that might occur at segment boundaries. For example, in a scenario with a sample rate of 44.1 kHz, a one-second audio segment would contain 44,100 data points. If the segment length is set to 5 seconds, each segment would encompass 220,500 samples. With an overlap of 2 seconds, each segment would share 88,200 samples with its predecessor, ensuring smooth transitions and coverage.

In one embodiment, following the segmentation process, each audio chunk is passed through an audio classifier module (e.g. 112 in FIG. 1). This step begins with loading a pre-trained classification model configured to return the top classification result for each segment. The pre-trained data may be optimized for accuracy and processing efficiency.

In some embodiments, before classification, each segment undergoes a normalization process. This involves dividing the audio values by a fixed value, for example the maximum possible value for 16-bit audio (32,767), ensuring that the input data falls within the appropriate range for the classifier. In some embodiments, the audio is instead divided by an alternative value, for example the maximum value recorded in the audio segment (to provide maximum dynamic range to the classifier). In some embodiments, the normalizer may only divide the audio by the maximum value recorded in the audio segment if that maximum value exceeds some fixed threshold, for example in order to avoid over-amplification of white noise in a segment of audio that contains only silence. This normalization step is crucial for maintaining consistency and improving the accuracy of our speech detection.

The audio classifier module evaluates each normalized segment, generating classification results, including labels and confidence scores. Quality control measures may be taken by considering a segment as containing valid speech only if the audio classifier module assigns it a confidence score exceeding a threshold, for example 0.80. In some embodiments, a different threshold may be used, for example 0.6, 0.65, 0.7, 0.75, 0.85, or 0.9. This threshold helps minimize false positives and ensures the reliability of speech detection.

After processing all segments, the system disclosed herein may combine the identified speech-containing segments into a single audio file. During this compilation, the system may remove the overlap between consecutive segments to avoid any duplication of audio data. This approach ensures that the final combined audio data structure maintains continuity without repeating any part of the speech, resulting in a streamlined audio file containing only the relevant speech segments.

The resulting audio file, representing a distilled version of the original input focusing on detected speech, is then saved, for example in an output directory on a non-transitory computer-readable medium, or alternatively may be stored in a transitory memory. This final product is a resource for further analysis, transcription, or other downstream processing tasks.

The ASR module may be configured to convert and store audio segments as vectors, for example as JSON vectors of key-value pairs. Multiple ASR models were evaluated for transcription, including Facebook's MMS-1B (see Pratap, V., et al., Arxiv, 2023), Nvidia's parakeet-rent-1.1b (see Nvidia. Parakeet-rent-1.1, 2024.), and OpenAI's whisper-large-v3 (Radford, A., et al., Intl. Conf. ML, 2023). The word error rate of mms-1b was found to be significantly higher than parakeet-rent and whisper-large-v3; for the latter two, the error rate was comparable. In one embodiment, the WhisperX implementation of Whisper (see Bain, M., et al., Interspeech, 2023) was selected as it provides a built-in pipeline for transcription using Whisper, accurate timestamps using wav2vec2, and Speaker Diarization using PyAnnotate (see Plaqet, A., et al., In proc. Interspeech, 2023) at a reasonable inference speed. In one embodiment, an ASR module may provide as one output a JSON schedule vector in the format of the example vector below:

```
{
      “url” : “stream.revma.ihrhls.com/zc3014”:
      “radio_name” : “KENI”,
      “time” : [“08:00”: “14:00”: “17:00”: “21:30”],
      “state”: “AK”
}
```

The example vector includes the URL of the audio stream, the callsign of the radio station recorded, the time indices recorded, and the state where the radio station primarily broadcasts. The time indices are stored as a set of start-finish pairs, and so the schedule vector contains broadcast audio data from 8 AM-2 PM and then from 5 PM to 9:30 PM.

Another output of the ASR module may be a transcript vector, which may for example have the format of the example vector reproduced below:

```
{
    “start”: 946.93,
    “end”: 948.391,
    “text”: “Here's Anna with headlines.”:
    “speaker”: “SPEAKER_04”
  },
  {
    “start”: 948.532,
    “end”: 959.54,
    “text”: “Pope Francis today has accepted the retirement of the longtime Archbishop of
Boston, Cardinal Sean O'Malley and chosen Providence Bishop Richard Henning to be his
successor.”:
    “speaker”: “SPEAKER_19”
  },
  {
    “start”: 960.601,
    “end”: 964.004,
    “text”: “Tropical Storm Debbie is now a hurricane.”:
    “speaker”: “SPEAKER_19”
  },
  {
    “start”: 964.585,
    “end”: 965.045,
    “text”: “What, Matt?”:
    “speaker”: “SPEAKER_19”
  },
  {
    “start”: 966.766,
    “end”: 968.087,
    “text”: “Oh, no, my mic is still alive.”:
    “speaker”: “SPEAKER_04”
  }
```

As shown in the above example, in some embodiments, audio streams transcriptions are stored as vectors of segments, where each segment contains a start and end timestamp, the transcribed text, and a speaker identifier. In some embodiments, an audio stream segment element in an audio stream segment vector may further comprise other data about the transcription, for example the language spoken, a confidence value in the transcription, a speaking volume, a sentiment score, etc.

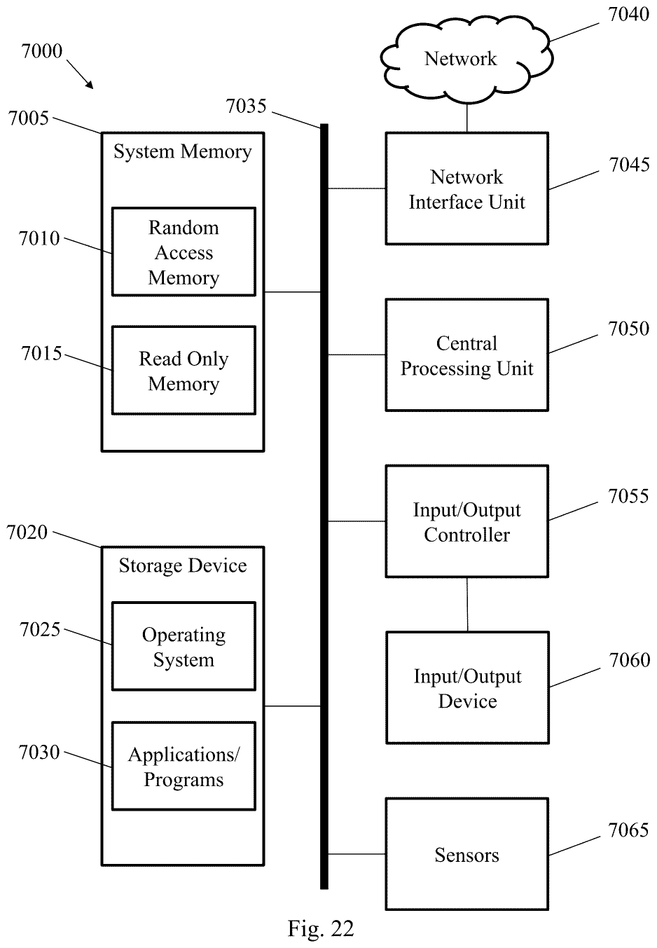

FIG. 22 and the following discussion are intended to provide a brief, general description of a suitable computing environment in which the invention may be implemented. While the invention is described above in the general context of program modules that execute in conjunction with an application program that runs on an operating system on a computer, those skilled in the art will recognize that the invention may also be implemented in combination with other program modules.

Generally, program modules include routines, programs, components, data structures, and other types of structures that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote memory storage devices.

FIG. 22 depicts an illustrative computer architecture for the computer 7000 for practicing the various embodiments of the invention. The computer architecture shown in FIG. 22 illustrates a conventional personal computer, including a central processing unit 7050 (“CPU”), a system memory 7005, including a random access memory 7010 (“RAM”), and a read-only memory (“ROM”) 7015, and a system bus 7035 that couples the system memory 7005 to the CPU 7050. A basic input/output system containing the basic routines that help to transfer information between elements within the computer, such as during startup, is stored in the ROM 7015. The computer 7000 further includes a storage device 7020 for storing an operating system 7025, application/program 7030, and data.

The storage device 7020 is connected to the CPU 7050 through a storage controller (not shown) connected to the bus 7035. The storage device 7020 and its associated computer-readable media provide non-volatile storage for the computer 7000. Although the description of computer-readable media contained herein refers to a storage device, such as a hard disk or CD-ROM drive, it should be appreciated by those skilled in the art that computer-readable media can be any available media that can be accessed by the computer 7000.

By way of example, and not to be limiting, computer-readable media may comprise computer storage media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other medium which can be used to store the desired information and which can be accessed by the computer.

According to various embodiments of the invention, the computer 7000 may operate in a networked environment using logical connections to remote computers through a network 7040, such as TCP/IP network such as the Internet or an intranet. The computer 7000 may connect to the network 7040 through a network interface unit 7045 connected to the bus 7035. It should be appreciated that the network interface unit 7045 may also be utilized to connect to other types of networks and remote computer systems.

The computer 7000 may also include an input/output controller 7055 for receiving and processing input from a number of input/output devices 7060, including a keyboard, a mouse, a touchscreen, a camera, a microphone, a controller, a joystick, or other type of input device. Similarly, the input/output controller 7055 may provide output to a display screen, a printer, a speaker, or other type of output device. The computer 7000 can connect to the input/output device 7060 via a wired connection including, but not limited to, fiber optic, Ethernet, or copper wire or wireless means including, but not limited to, Wi-Fi, Bluetooth, Near-Field Communication (NFC), infrared, or other suitable wired or wireless connections.

As mentioned briefly above, a number of program modules and data files may be stored in the storage device 7020 and/or RAM 7010 of the computer 7000, including an operating system 7025 suitable for controlling the operation of a networked computer. The storage device 7020 and RAM 7010 may also store one or more applications/programs 7030. In particular, the storage device 7020 and RAM 7010 may store an application/program 7030 for providing a variety of functionalities to a user. For instance, the application/program 7030 may comprise many types of programs such as a word processing application, a spreadsheet application, a desktop publishing application, a database application, a gaming application, internet browsing application, electronic mail application, messaging application, and the like. According to an embodiment of the present invention, the application/program 7030 comprises a multiple functionality software application for providing word processing functionality, slide presentation functionality, spreadsheet functionality, database functionality and the like.

The computer 7000 in some embodiments can include a variety of sensors 7065 for monitoring the environment surrounding and the environment internal to the computer 7000. These sensors 7065 can include a Global Positioning System (GPS) sensor, a photosensitive sensor, a gyroscope, a magnetometer, thermometer, a proximity sensor, an accelerometer, a microphone, biometric sensor, barometer, humidity sensor, radiation sensor, or any other suitable sensor.

The disclosures of each and every patent, patent application, and publication cited herein are hereby incorporated herein by reference in their entirety. While this invention has been disclosed with reference to specific embodiments, it is apparent that other embodiments and variations of this invention may be devised by others skilled in the art without departing from the true spirit and scope of the invention. The appended claims are intended to be construed to include all such embodiments and equivalent variations.

### EXPERIMENTAL EXAMPLES

The invention is further described in detail using the following experimental examples. These examples are provided for illustration only and are not intended to be limiting unless otherwise specified. Thus, the invention should in no way be construed as being limited to the following examples but rather should be construed to encompass any variations that become evident as a result of the teaching provided herein.

Without further description, it is believed that one of the ordinary skills in art can make and utilize the system and method of the present invention using the preceding description and the following illustrative examples. The following working examples, therefore, specifically point out the exemplary embodiments of the present invention and are not to be construed as limiting in any way the remainder of the disclosure.

### Experimental Case Studies

Having a time-stamped radio transcript database that captures a unique snapshot of American political broadcasting, the database was analyzed in the following three experiments. The experiments demonstrate how the disclosed system can be used to explore the spread of a specific misinformation claim, amplify information by a network of radio stations, and assess the overall sentiment of major party candidates.

### Experiment #1: Spread of a Political Narrative

This experiment aimed to understand how a system like the one disclosed herein could be useful in gaining insights into political/election discourse.

One aim of the experiment was to track a narrative that revolved around the integrity of the 2020 US presidential election in Fulton County, Georgia (US), that stemmed from a report analyzing the election in Georgia, published by a campaign spokesperson, claiming that the election was stolen from Donald Trump. Taking this narrative as an example, a search was performed in the corpus for matching narrative pieces. The dataset returned at least 50 positive samples, including a majority amplifying the claim in this narrative, a handful reporting, and a few debunking it.

A second search was performed based on a narrative that appeared on the airwaves just after the Biden-Trump debate on Jun. 27, 2024; this date coincided with the start of data collection. The main rhetoric focused on inconsistencies in the logic and accuracy tests conducted on voting machines.

The summarized narrative is important to understanding the context and background upon which this experiment is built. As such, it is quoted in its entirety below:

“There were discrepancies in the 2020 presidential election vote count in Fulton County, Georgia. Specifically, 17,000 votes needed to be reconciled before certification. The elections group was involved in various aspects of the 2020 election across multiple states. The Georgia State Election Board investigated the recount process and confirmed some rule violations by Fulton County. Over 20,000 ballots were added to both the original results and the machine recount without proper justification. There were missing ballot images and duplicate ballots, which made the election suspicious. The secretary of state's office and the state election board investigated, and there was a lack of transparency and accountability. Since the 2020 election in Georgia was inaccurate, the presidential election was stolen.”

First, an analysis was performed using a manual methodology. For the purposes of the experiment, a list of keywords was prepared. As part of making or discovering the method and/or system disclosed herein, the keywords were converted to transcript filtering rules. The rules developed are in Table 4 below

TABLE 4
Transcript filtering rules

| | |
|---|---|
| Logic and accuracy and test | Or logic and accuracy |
| Or logic test* and election | Or l and a |
| Or logic testing and vot* | Or logic/accuracy |
| Or accuracy testing and vot* | Or logic/accuracy |
| Or accuracy test* and | Or la testing |
| election | |
| Or voting machine test* | Or elections group |
| Or machine test and | Or <claimant's name> |
| election | |
| Or machine test and vot* | Or <website's name> |

Transcripts acquired from radio stations in Georgia were filtered using the above keywords, e.g., a filtered transcript should contain the keywords “logic,” “accuracy,” and “test.” However, this resulted in only a few matches. When the search was expanded nationwide, the system returned 120 samples. As keywords acted as a broad net and needed exact citations, an internal human study was performed among four individuals. The 120 samples were split into four overlapping sets, so each transcript was seen at by at least two different individuals. Then, the responses were aggregated to form a ground truth with 53 transcripts—34 supporting the claim, 16 neutrally reporting, and three actively debunking the claim. An excerpt from a June 2024 transcript that matched.

Second, an analysis was performed with an automated methodology. The manual method depended on curated filtration rules to reduce the search space, which is non-trivial for arbitrary narratives. Therefore, for the automated analysis, Automated Retrieval-Augmented Generation (a-rag) was used.

The LLM was provided with a prompt: “Were there discrepancies in the 2020 presidential election vote count in Fulton County, Georgia?”

The LLM responded, “Yes, there were claims of discrepancies, which ported that Fulton County had double-counted thousands of ballots during a recount, resulting in discrepancies in the vote count. This issue was brought up by a whistle-blower and led to an investigation. The Georgia election board voted 3-2 to request an investigation by Attorney General Chris Carr into the matter. Though the election outcome was not altered by these discrepancies, the incident raised concerns about the accuracy and reliability of the Georgia election process in 2020.”

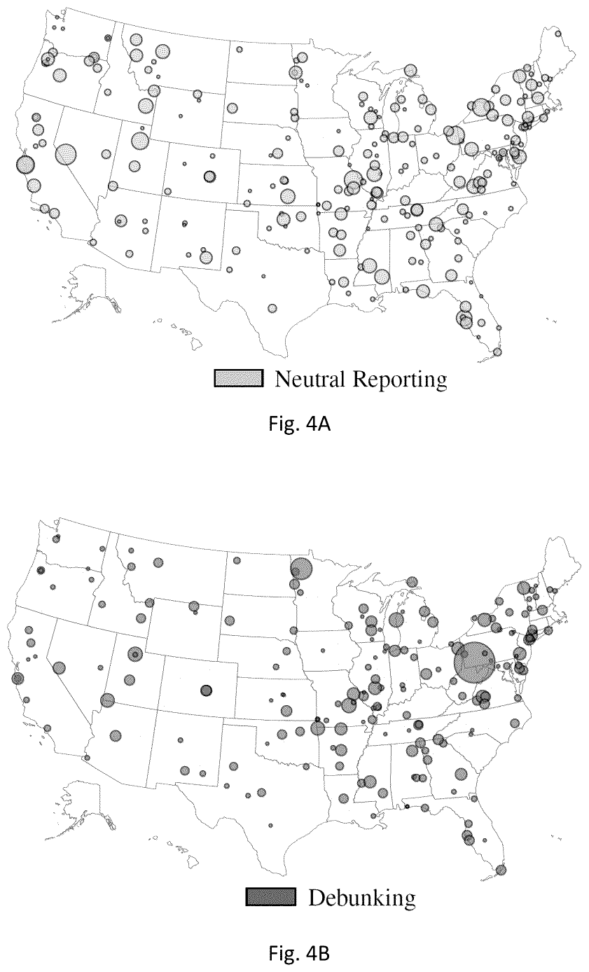

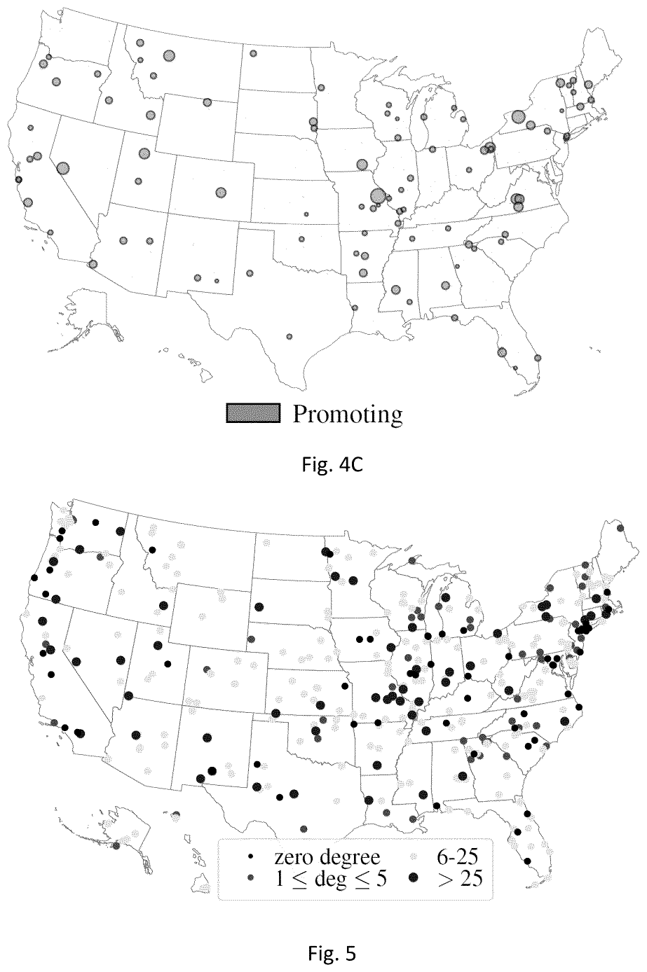

While the retrieval mechanism yielded solid leads, there was no ground truth against which to compare it. Therefore, to get a holistic understanding of the scope of the narrative, a search was performed through the whole dataset. For each summarized transcript, LLaMa-3.1-8B-Instruct (sometimes referred to herein as “llama,” see Dubey, A., et al. arxiv: 2407.21783 2024) was used to count the number of mentions related to “2020 election being stolen, rigged, or false.” If a transcript came out positive, the LLM labeled the transcript for its stance, i.e., promoting, neutral reporting, or debunking. 3,497 mentions were found across the corpus. FIG. 4A-FIG. 4C illustrate the occurrence of such mentions and provides a breakdown across the stances.

While the manual method yielded 53 matches, the automated method extracted 3,497 matches, providing a superior estimate of the media landscape covering a contentious narrative. The majority of mentions (53.3%) were examples of neutral reporting, followed by 36.3% of debunking the narrative, with only a 10.4% minority promoting it. This experiment is an example of how one can gauge the level of traction a narrative gets on the radio.

### Experiment #2: Content Syndication Across Radio Stations

The analysis of radio station transcripts revealed extensive verbatim duplications across geographically dispersed stations, suggesting the existence of a complex social network among broadcasters. This phenomenon, observed across state boundaries and varying time frames, indicates structured information sharing among media outlets. For instance, a specific claim regarding a presidential candidate's alleged substance use before a debate was simultaneously broadcast by 31 distinct stations. While this synchronicity in content dissemination does not establish causality between broadcasts, it strongly suggests coordinated information sharing.

To investigate information-sharing patterns, an algorithm was developed to identify unique broadcasts and their repeats, comprising the following steps:

Step 1: Locality-sensitive hashes were computed of text-only portions of all transcripts using minhash. Transcript pairs with Jaccard similarity exceeding a pre-defined threshold (0=0.8) were considered related, and thus added to each other's adjacency list. As causality is hard to predict, such a content-based match was only considered to suggest a symmetric connection.

Step 2: utilizing these adjacency lists, the search was expanded to identify distinct subgroups through a breadth-first search (BFS) approach. Starting with the initial list of unvisited transcripts and BFS all connected transcripts, exhaustive lists of resonating broadcasts were formed that matched thematically, as demonstrated in FIG. 4A-FIG. 4C.

Step 3: To identify long-term collaborations and information propagation hubs, a technical procedure was generated and executed that contains a series of steps that refine the network of broadcasts, as demonstrated in FIG. 5. First, broadcasters in the same subgroup on consecutive dates were merged (e.g., the method would consolidate KM_WXYZ_2024_07_15_13_30 and LM_WABC_2024_07_16_02_00 if they broadcast identical content). Next, single-broadcaster subgroups were discarded, eliminating instances of content repetition on two consecutive days.

In the remaining subgroups, station names such as KLMN and KOPQ were extracted, for each unique station. Next, single-station lists were removed, further refining the network by eliminating stations that broadcast their content several days apart. Then, bidirectional edges were created between stations in each subgroup (e.g., for stations KLMN, KOPQ, and KRST, edges were created between all pairs). After that, uniqueness across rows and order invariance were ensured, standardizing edge representation. Finally, pair-wise connections were generated, excluding self-connections.

This unique combination of algorithmic analysis of collected data produced unexpected results not yet seen, or at least not yet published, in the technical field of endeavor of this application. Steps 1 and 2 of the technical analysis procedure identified 22,149 unique subgroups broadcasting similar content. After executing the unique method steps within step 3, wherein the network was refined, the number of identified subgroups was reduced to 1,776 subgroups with 2,684 unique edges. An analysis of the results discovered that this content mirroring pattern suggests coordinated messaging strategies transcending geographical and temporal boundaries. FIG. 5 illustrates this broadcasting station network.

The analysis framework turned up several notable findings. For one, fifteen stations exhibiting over 40 connections suggest that undiscovered key information exchanges have developed. Further, a ten-station network spanning ten mid-western and southern states shared content several times, indicating a regional syndication network. Also, 50 stations remained disconnected in the final network, potentially indicating non-participation in syndicates, self-broadcasters, or representing false negatives in the analysis. For example, a station in New Jersey, despite being a major broadcaster, showed no connections in the network, suggesting it might prioritize original content or use syndication methods which the analysis could not capture. Finally, the analysis revealed several content propagation chains, such as a station in Iowa which first broadcast a story, then another one in Tennessee echoed it ten days later, and then another in Illinois after an additional eight days.

This experiment enhances the understanding of information propagation in legacy media networks. The observed patterns of information propagation in legacy media networks are notoriously difficult to track without implementing a novel approach to more quickly and more accurately acquire, extract, and analyze data. Further, the research raises important questions about media diversity, centralization of narrative control by major syndicates, and the potential for rapid, wide-scale dissemination of specific viewpoints across seemingly independent broadcast radio channels. Further, this exemplary method of use provides a novel, simple approach to mapping information flow and identifying potential echo chambers in the broadcasting landscape.

### Experiment #3: Presidential Candidates' Favorability Trends

This experiment used data from the summer of 2024. This is notable as it marks a pivotal period in American politics during which public perception of presidential candidates fluctuated in response to unfolding events. This experiment delves into these dynamics through sentiment analysis of the dataset by processing the curated dataset through the disclosed sentiment analysis method. Further, this use case focuses on three prominent American political figures. Namely Kamala Harris, Joe Biden, and Donald Trump.

Relevant text segments were isolated via keyword matching. Instances of multiple candidate mentions were excluded to ensure sentiment clarity. To distill these multifaceted counts into a single, comprehensible metric, a normalized sentiment score was developed S̅∈[0,1]

$$\overline{S} = \frac{( 2 \cdot {S}_{⊕} + 1 \cdot {S}_{⊙} + 0 \cdot {S}_{⊖} )}{( 2 \cdot {S}_{T} )} \qquad Equation 5$$

$${S}_{⊕} , {S}_{⊙} , {S}_{⊖} ∈ {𝒵}^{+}$$

$${S}_{⊕} + {S}_{⊙} + {S}_{⊖} = {S}_{T}$$

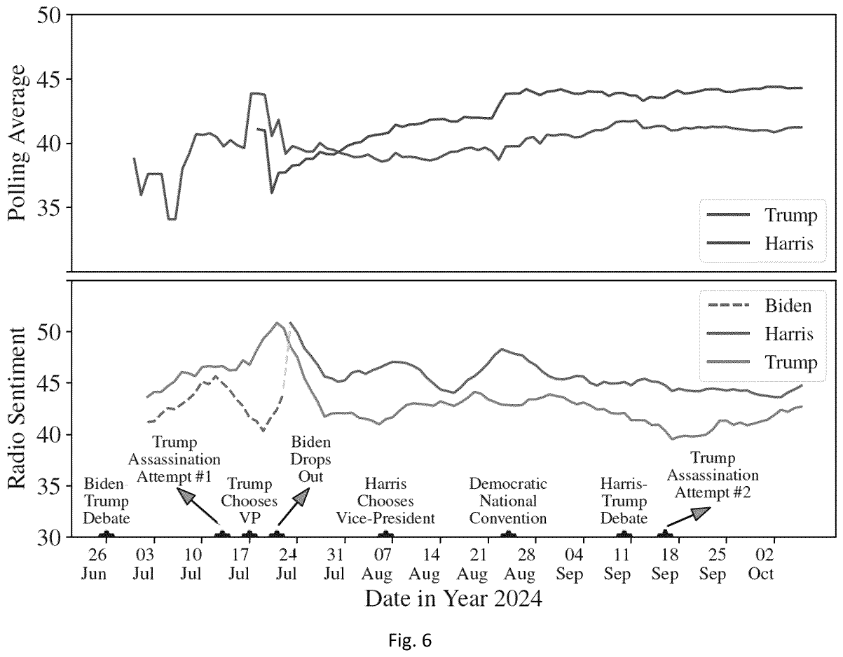

Equation 5 captures the nuances of all three sentiment categories while providing a holistic view of content sentiment. The lower graph in FIG. 6 illustrates the ebb and flow of nationwide sentiment as computed from the transcribed radio content, smoothed with a 7-day moving average to reveal underlying trends, as radio shows had less programming during weekends, which caused weekly dips.

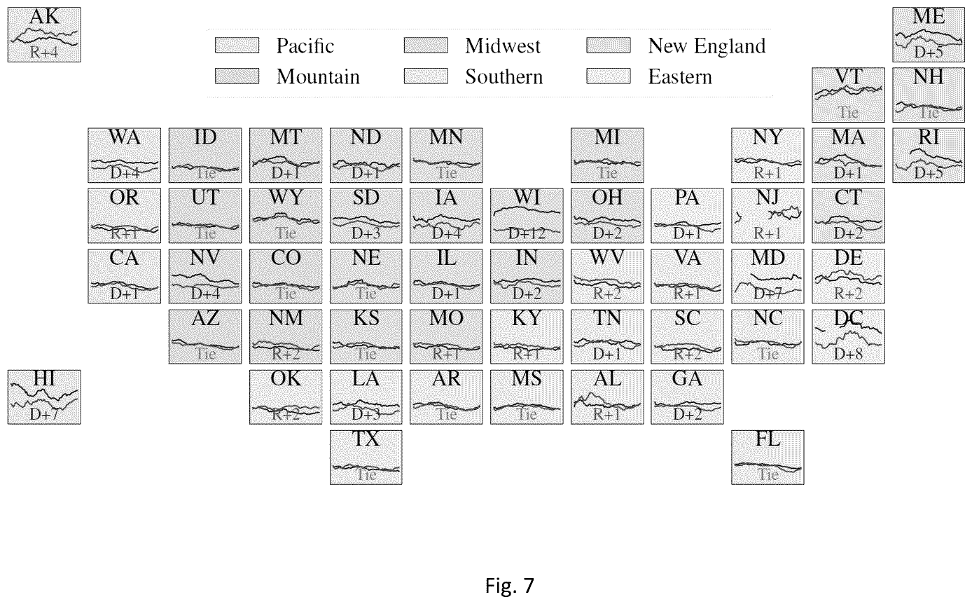

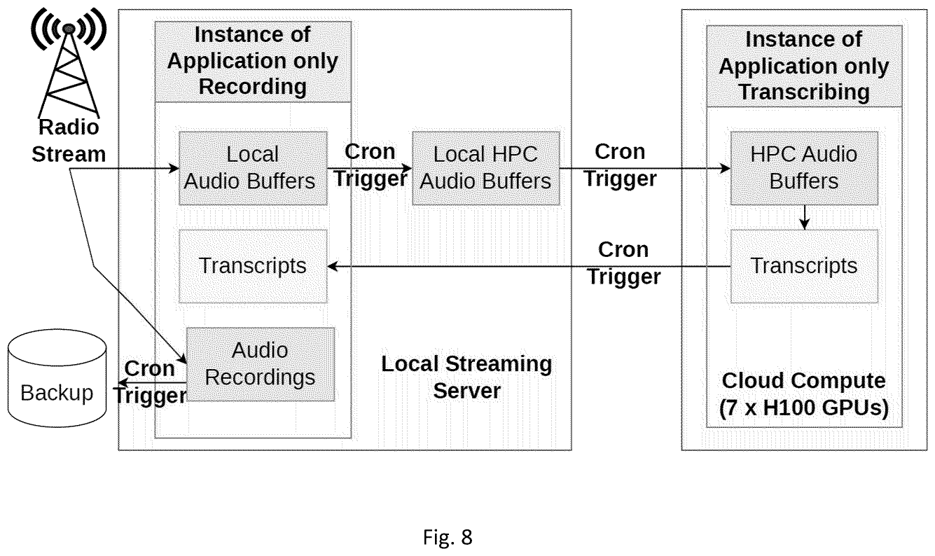

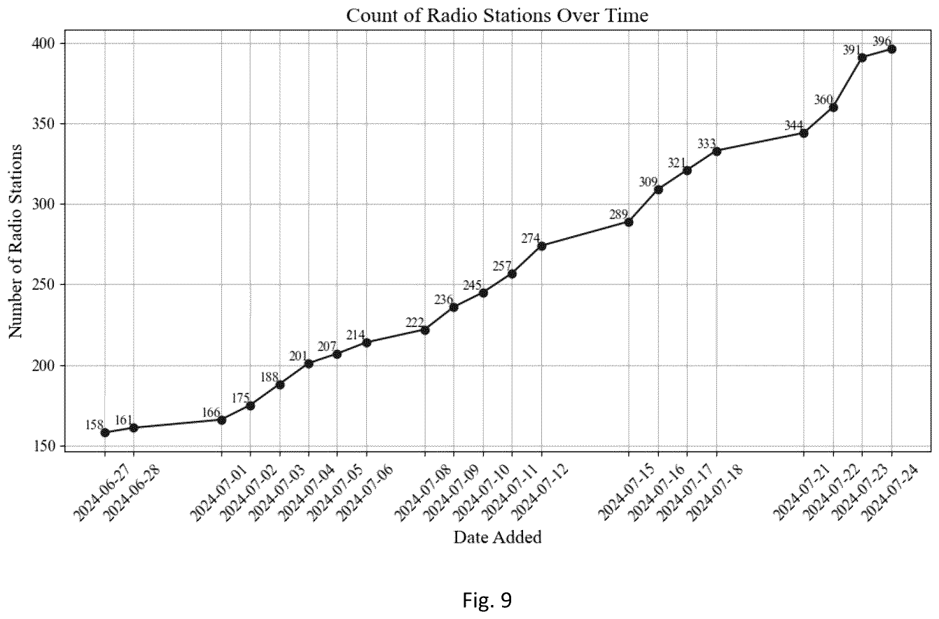

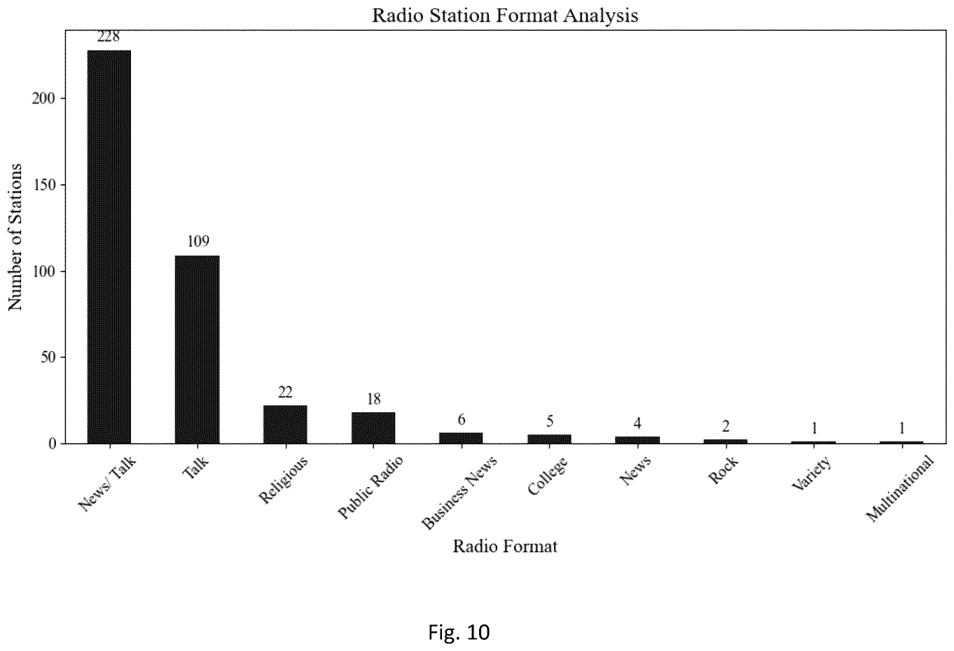

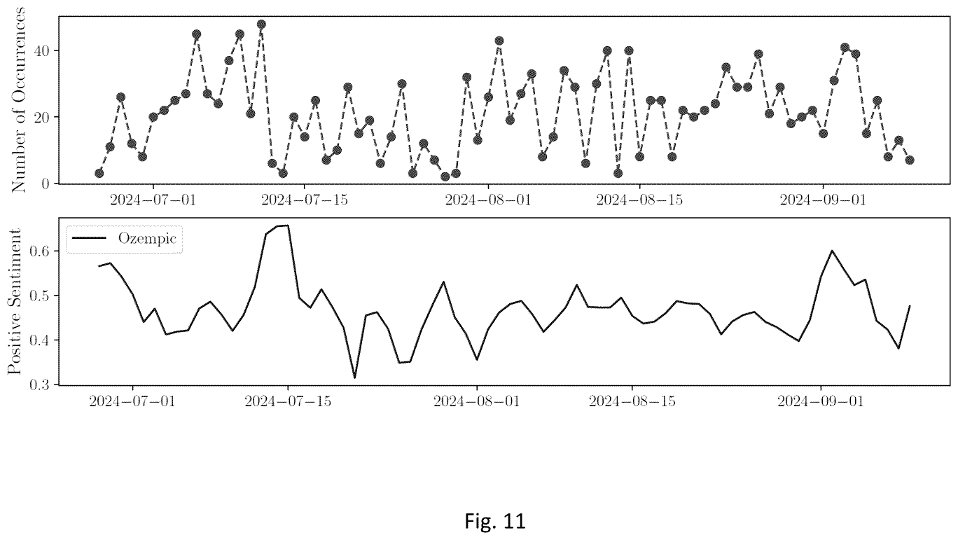

Annotated political events offer context for significant shifts, depicting how key moments shaped public perception. The upper part of FIG. 6 was derived from the raw data of Nate Silver's model (see Silver, N., 2024.) by diving deeper into FIG. 7. This deep dive breaks the trends down according to state-specific sentiments, reflecting local political climates or the impact of targeted campaign strategies.

The sentiment predictions demonstrate similarity with the 2024 presidential polling averages, which in turn are based on reputable national polls and summarized by a competitive model from a prominent pollster. This alignment suggests that radio content analysis can serve as a valuable proxy for public sentiment, offering real-time insights into political trends.

The state-wise sentiment analysis reveals a granular view of political leanings across the country. However, some anomalies emerged, such as the surprisingly strong democratic lead in Wisconsin (D+12). This discrepancy was first observed between state-level and nationwide using the system and/or method disclosed herein.

### Related Work in Radio Content Analysis

While radio has a century-long history as a broadcasting medium for entertainment and information semination, modern radio in the U.S. has its roots in the deregulation adopted in the Telecommunications Act of 1996 that fundamentally reshaped the U.S. radio industry. The deregulation altered the industry's economics, with large conglomerates implementing cost-cutting measures such as staff reductions and automated programming while also changing advertising dynamics by offering multi-station, multi-market packages to advertisers (see Drushel, B. E. j. media econ., 1998). Also, due to the rise in online music streaming and piracy making music expensive to broadcast, talk shows gained popularity. iHeartMedia stations were not included in this study as they have restrictive terms of service, but several other syndicates were found (see Berry, J. M., et al., Ps: political science & politics, 2011).

Hofstetter (see Hofstetter, C. R., et al., Columbia university press, 2002; and Hofstetter, C. R., et al., j. broadcasting & elec. media, 1997) studied how radio shows shape public opinion and found that they play several roles for their listeners, including seeking information, contextualizing, interpreting the information, and serving as a proxy for interaction with the hosts and guests.

From 2006 to 2011, DARPA undertook efforts to collect and transcribe cross-lingual broadcast news and talk shows under its GALE project. In 2019, RadioTalk was the first work that created a large corpus of talk radio transcripts comprising 284,000 hours of radio and 2.8 billion words. The authors conducted transcription using a TDNN model, which produced noisy samples with a WER of 13.1%. Using this dataset, Brannon and Roy (see Brannon, W., et al., Scientific reports, 2024) compared the speed of news on Twitter versus radio during 2019-2021 and found that Twitter news circulates and evaporates faster and is more negative than radio. A follow-up work assembled the Interview media dialog dataset (see Majumder, B. P., et al., Assoc. Comp. Ling., 2020) comprising a collection of 20 years of NPR radio transcripts that enables discourse pattern analysis. The disclosed system simultaneously provides an end-to-end pipeline based on modern LLMs with 8.3% WER, which continuously produces a rich dataset while being able to run real-time analytics to poll it.

### Social Media Analytics Framework

Aggarwal et al. (see Agarwal, A., et al., ACM, 2024) developed a multimodal framework to track bias and incivility on Indian TV news. Saez-Trumper et al. (see Saez-Trumper, D., et al., ACM, 2013) used unsupervised methods on a geographically diverse set of news sources by examining ‘gate-keeping’ coverage and statement bias to find bias in online news. Ribeiro et al. (see Ribeiro, F., et al., AAAI, 2018) employed scalable methodologies that leverage social media's advertiser interfaces to infer the ideological slant of thousands of news outlets. Allen et al. (see Allen, J., et al., Science, 2024) analyzed Facebook posts during the COVID pandemic for content in the grey area and found that this unflagged content cast doubts on vaccine safety or efficacy and was 46-fold more consequential for driving vaccine hesitancy than flagged misinformation. Contrary to them, the disclosed system provides a tool to measure radio content in real-time, with the case studies performed primarily to showcase its capabilities, and it does not provide any subjective labeling.

### CONCLUSION

Strict ethical principles were maintained during the data collection, usage, and analysis conducted in this work. The disclosed system utilizes data broadcast to the web on public radio streams, which falls under fair use unless explicitly restricted under terms of service. All broadcasters' license agreements were meticulously reviewed where applicable and stations with such restrictions were excluded. The dataset does not contain personally identifying information (PII) about listeners. The dataset may include PII about advertisers (e.g., names and contact information of organizational representatives) and show hosts. Given the focus on political topics, the system was implemented with a goal to avoid political bias. It is acknowledged that the usage of LLMs in the disclosed analysis may inherently exhibit some biases due to their respective training data.

The disclosed analysis does not incorporate population data along with the reach of each station's waves to calculate exposure to each station. Nielsen Audio sells exposure ratings, and FCC hosts ground conductivity data. Only stations which are live-streamed over the Internet were included. Terrestrial-only radio broadcasts would require dedicated hardware (an antenna, transceiver, and recording equipment). Finally, while the disclosed system is widely applicable, the analysis herein derives results and conclusions from only the available radio streams. An important direction for future work is to broaden the scope to worldwide radio live streams; due to the multilingual nature of LLMs, it is anticipated that the disclosed system will scale up with no significant design changes.

Using the disclosed system, nearly half a million hours of news/talk radio content were collected over a 100-day period of significant political activity in the United States. Three experiments were conducted: tracking political narratives with political scientists, building a social network of radio stations, and predicting political trends in real time. The present disclosure highlights the depth of insights derivable from this comprehensive dataset.

### REFERENCES

The below publications are incorporated herein by reference in their entireties.
Radio Locator, 2024. Accessed on Oct. 13, 2024.
Agarwal, A., Priyadarshi, P., Sinha, S., Gupta, S., Kangra, H., kumara guru, P., and Carmella, K. Television discourse decoded: comprehensive multimodal analytics at scale. In Proceedings of the 30th ACM signed conference on knowledge discovery and data mining (New York, NY, USA, 2024), KDD '24, an association for computing machinery, p. 4752-4763.
Allen, J., Watts, D. J., and Rand, D. G. Quantifying the impact of misinformation and vaccine-skeptical content on Facebook. Science 384, 6699 (2024), eadk3451.
Bain, M., Huh, J., Han, T., and Zisserman, A. Whisperx: time-accurate speech transcription of long-form audio. Interspeech 2023 (2023).
Beeferman, D., Brannon, W., and Roy, D. Radiotalk: a large-scale corpus of talk radio transcripts. In Interspeech 2019 (2019), pp. 564-568.
Berry, J. M., and Sobieraj, S. Understanding the rise of talk radio. Ps: political science & politics 44, 4 (2011), 762-767.
Brannon, W., and Roy, D. The speed of news in twitter (x) versus radio. Scientific reports 14, 1 (2024), 11939.
Camacho-Collados, J., Rezaee, K., Riahi, T., Ushio, A., Loureiro, D., Antypas, D., Boisson, J., Espinosa Anke, L., et al. Tweetnlp: cutting-edge natural language processing for social media. In proceedings of the 2022 conference on empirical methods in natural language processing: system demonstrations (Abu Dhabi, UAE, December 2022), Association for Computational Linguistics, pp. 38-49.
Chen, J., et al., Bge M3-Embedding: Multi-Lingual, Multi-Functionality, Multi-Granularity Text Embeddings Through Self-Knowledge Distillation, 2024.
Chong, D., and Druckman, J. N. A theory of framing and opinion formation in competitive elite environments. Journal of communication 57, 1 (2007), 99-118.
Dilliplane, S., Activation, conversion, or reinforcement? The impact of partisan news exposure on vote choice. American journal of political science 58, 1 (2014), 79-94.
Douze, M., et al., The FAISS library.
Drushel, B. E. The telecommunications act of 1996 and radio market structure. Journal of media economics 11, 3 (1998), 3-20.
Dubey, A., et al. The llama 3 herd of models. Arxiv preprint arxiv: 2407.21783 (2024).
Hofstetter, C. R., et al., Information, misinformation, and political talk radio. In rushed to judgment: talk radio, persuasion, and american political behavior. Columbia university press, 2002, pp. 106-118.
Hofstetter, C. R., and Gianos, C. L., Political talk radio: actions speak louder than words. Journal of broadcasting & electronic media 41, 4 (1997), 501-515.
Kim, Y. M., and Vishak, J. Just laugh! You don't need to remember: the effects of entertainment media on political information acquisition and information processing in political judgment. Journal of communication 58, 2 (2008), 338-360.
Lee, G., and Cappella, J. N. The effects of political talk radio on political attitude formation: exposure versus knowledge. Political communication 18, 4 (2001), 369-394.
Majumder, B. P., et al., Interview: large-scale modeling of media dialog with discourse patterns and knowledge grounding. In proceedings of the 2020 conference on empirical methods in natural language processing (emnlp) (online, November 2020), b. Webber, t. Cohn, y. He, and y. Liu, eds., association for computational linguistics, pp. 8129-8141.
Nvidia. Parakeet-rent-1.1 b. huggingface.co/nvidia/parakeet-rnnt-1.1b, 2024. Accessed on Oct. 13, 2024.
Pew Research Center. News platform fact sheet, 2024. Accessed Oct. 10, 2024.
Plaqet, A., and Bredin, H. Powerset multi-class cross entropy loss for neural speaker diarization. In proc. Interspeech 2023 (2023).
Pratap, V., et al., Scaling speech technology to 1,000±languages. Arxiv (2023).
Radford, A., et al., Robust speech recognition via large-scale weak supervision. In international conference on machine learning (2023), pmlr, pp. 28492-28518.
Rekesh, D., et al., Fast conformer with linearly scalable attention for efficient speech recognition. In 2023 ieee automatic speech recognition and understanding workshop (asru) (2023), ieee, pp. 1-8.
Ribeiro, F., et al., Media bias monitor: quantifying biases of social media news outlets at large-scale. In proceedings of the international aaai conference on web and social media (2018), vol. 12.
Saez-Trumper, D., et al., Social media news communities: gatekeeping, coverage, and statement bias. In proceedings of the 22nd acm international conference on information & knowledge management (2013), pp. 1679-1684.
Silver, N. Nate silver 2024 president election polls model, 2024. Accessed on Oct. 13, 2024.
Team, G., et al. Gemini: a family of highly capable multimodal models. Arxiv preprint arxiv: 2312.11805 (2023).
Ars Technica, Defense department funds massive speech recognition and translation program. Accessed on Oct. 13, 2024.
Tesler, M. Elite domination of public doubts about climate change (not evolution). Political communication 35, 2 (2018), 306-326.
Westwood one. Nielsen: am/fm radio expands its ratings lead over tv and smashing am/fm radio's drive time myth, 3 2024. Accessed Oct. 10, 2024.
Wikipedia contributors. Wikipedia: size of wikipedia. en.wikipedia.org/wiki/wikipedia: size_of_wikipedia, 2024. Accessed on Oct. 13, 2024.
Zaller, J. The nature and origins of mass opinion. Cambridge university (1992).

What is claimed is:

1. A method of identifying speaker sentiment from a live media broadcast comprising:
obtaining, with a radio streamer module, an audio stream of a live media broadcast, the audio stream comprising at least one speech source;
splitting the audio stream into a set of fixed-length audio files;
transcribing each of the set of fixed-length audio files to obtain calculated text data of content of the at least one speech source; and
calculating a sentiment from the speech waveform and the calculated text data.

2. The method of claim 1, further comprising storing the calculated sentiment and the calculated text data in a database on a non-transitory computer-readable medium.

3. The method of claim 2, further comprising storing the at least one speech waveform in the database.

4. The method of claim 1, wherein the at least one speech source comprises a plurality of speech sources, the method further comprising the step of assigning a unique speaker identifier to each fixed length audio file in the set of fixed length audio files.

5. The method of claim 1, further comprising storing the calculated text data of each fixed-length audio file in the audio stream to a vector of transcription data structures.

6. The method of claim 5, wherein each transcription data structure comprises the calculated text data, a speaker identifier, a start time index, and a stop time index.

7. The method of claim 1, wherein the fixed-length audio files overlap one another.

8. The method of claim 1, further comprising:
calculating a further set of sentiments from a plurality of live media broadcasts in a geographic vicinity of the live media broadcast; and
calculating a media sentiment for the geographic vicinity from the linguistic context and the further set of linguistic contexts.

9. The method of claim 1, wherein the sentiment is calculated from the speech waveform less than one minute after the audio stream is obtained.

10. The method of claim 1, further comprising: translating the calculated text data from a first language to a second language.

11. The method of claim 1, further comprising:
querying at least one fact-checking database with the calculated text;
obtaining at least one fact-checking entry from the fact-checking database related to the calculated text; and
calculating an accuracy score of the calculated text based on the content of the fact-checking entry.

12. A system comprising a non-transitory computer-readable storage medium with instructions stored thereon, which when executed by a processor, perform steps comprising:
obtaining an audio stream of a live media broadcast, the audio stream comprising at least one speech source;
splitting the audio stream into a set of fixed-length audio files;
transcribing each of the set of fixed-length audio files to obtain calculated text data of content of the at least one speech source; and
calculating a sentiment from the speech waveform and the calculated text data.

13. The system of claim 12, the instructions further comprising storing the calculated sentiment and the calculated text data in a database on the non-transitory computer-readable medium.

14. The system of claim 12, the instructions further comprising storing the fixed-length audio files on the non-transitory computer-readable medium.

15. The system of claim 14, the instructions further comprising:
storing multiple copies of each of the set of fixed length audio files on the non-transitory computer readable medium; and
analyzing each of the set of fixed length audio files in parallel with multiple processes by accessing different copies of each fixed length audio file.

16. The system of claim 12, the instructions further comprising displaying a graphical user interface (GUI) for a user, the graphical user interface comprising the calculated sentiment and a geographical representation of a location of a source of the live media broadcast.

17. The system of claim 16, the instructions further comprising:
obtaining a set of audio streams of live media broadcasts;
performing the splitting, transcribing, and calculating sentiment steps on each of the set of audio streams; and
displaying, on the graphical user interface, a geographic visualization of calculated sentiment showing the location of each live media broadcast.

18. The system of claim 12, wherein the audio stream of the live media broadcast is obtained via an Internet radio stream.

19. The system of claim 12, further comprising a radiofrequency antenna and tuner communicatively connected to the processor, wherein the audio stream of the live media broadcast is obtained from the tuner.

20. The system of claim 12, the instructions further comprising storing the calculated text data of each fixed-length audio file in the audio stream to a vector of transcription data structures.
